(19) United States
(12) Patent Application Publication
(10) Pub. No.: US 2009/0097737 A1
(43) Pub. Date: Apr. 16, 2009

(54) VISUAL INSPECTION APPARATUS

(75) Inventors: Katsuyuki HASHIMOTO, Tokyo (JP); Hiroyuki TOKITA, Kamiina-gun (JP); Hiroshi NAIKI, Ina-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/329,847

(22) Filed: Dec. 8, 2008

(30) Foreign Application Priority Data
Dec. 10, 2004 (JP) P2004-359113
Jun. 8, 2006 (JP) PCT/JP2006/311515

(51) Int. Cl. G06K 9/00

(52) U.S. Cl. 382/145

(57) ABSTRACT

In a visual inspection apparatus according to the present invention, a carrier base 2 supports a substrate 1 and tilts the substrate 1. The light source 3 illuminates light onto the surface of the substrate 1. The image-pickup apparatus 4 upon capturing an image of the substrate 1 produces image data and puts them out to a control apparatus 6. The image-pickup apparatus 4 is disposed in the vicinity of an eye view position P of the inspector. The control apparatus 6 stores the image data put out from the image-capturing apparatus 4 into an internally-disposed storage section.

### BACKGROUND OF THE INVENTION

1. Field of the Invention

The present invention relates to a visual inspection apparatus for inspecting the external view of an inspection object such as a semiconductor wafer substrate. Priority is claimed on International Patent Application No. PCT/JP2006/311515, filed Jun. 8, 2008, the content of which is incorporated herein by reference.

2. Description of the Related Art

Inspections hitherto conducted in the manufacture of semiconductor wafer substrates aim to find defects including uneven surface finish or flaw on a photo-resist layer coated on a substrate. For example, a visual inspection apparatus conducts visual inspection for semiconductor wafers as follows (see Patent Documents 1 and 2). In the beginning, a semiconductor wafer mounted in an enclosure is taken out and transferred to a macro-inspection section by a transfer robot. A carrier base which is disposed in the macro-inspection section for supporting the semiconductor wafer is capable of tilting and rotating the semiconductor wafer. The inspector tilts the semiconductor wafer while manipulating a joystick provided on the visual inspection apparatus and tilting the carrier base automatically based on a prescribed recipe, and the quality of the wafer is determined based on a defect found by visual observation.

Subsequently, the semiconductor wafer is transferred to a micro-inspection section if necessary. The micro-inspection section observes a magnified image of a defect site on the surface of the semiconductor wafer by means of microscopic observation. After the micro-inspection, the semiconductor wafer is transferred by the transfer robot and stored into the enclosure again.

Automatic macro-inspection conducted in recent years captures an image of the full surface of a semiconductor wafer mounted on a stage (for example, see Patent Document 3). However, a macro-inspection apparatus using a conventional visual observation may be suitable in some cases because a promptly-recognizable large size defect or the back side inspection can be conducted in high speed. Therefore, a semiconductor wafer is rotated and tilted in the aforementioned macro-inspection using visual observation.

Patent document 1: Japanese Unexamined Patent Application, First Publication No. H9-186209
Patent document 2: Japanese Unexamined Patent Application, First Publication No. H6-349908
Patent document 3: Japanese Unexamined Patent Application, First Publication No. H7-27709

However, the macro-inspection using visual observation has been disadvantageous in some cases because an inspection appears to indicate different results, more specifically, a defect observed in an inspection using a tilt mechanism and a common recipe may be visible to an inspector but not to another inspector since factors such as illumination light, the tilting angle of the carrier base, and the position of the eyes of the inspector vary visibility for scattered components and diffraction components included in an observed image. In addition, it has been another drawback that it is difficult to share defect-associated information among inspectors who agree to the result of inspection since the defect can be observed by a single operator at a time, and since no record is stored for shape and position of a defect site.

The present invention was conceived in consideration of the aforementioned disadvantages, and an object of the present invention is to provide a visual inspection apparatus which allows a plurality of inspectors to share a defect-showing image obtained by means of visual inspection.

### SUMMARY OF THE INVENTION

The present invention was conceived in order to solve the aforementioned problems, and the present invention relates to a visual inspection apparatus, including: an inspection-object-holder section for conducting visual inspection to an inspection object, the inspection-object-holder section supporting the inspection object and tilting the inspection object; and an image-capturing section for capturing an image of the inspection object and producing image data, so that an optical axis of the image-capturing section is disposed to substantially coincide with a line of sight of an inspector who observes the inspection object during the visual inspection.

In addition, it is preferable that the visual inspection apparatus according to the present invention further includes: a illuminating section for illuminating the inspection object; a tilt-position-storage section for storing tilting-position-associated information associated with the inspection-object-holder section; a tilting-position-storing-and-operating section for storing the tilting-position-associated information into the tilt-position-storage section based on operation provided by the inspector who conducts visual observation for a defect of the inspection object; a section for detecting the information associated with the line of sight for recognizing operation provided to the tilting-position-storing-and-operating section and for detecting the information associated with the line of sight of the inspector directed toward the inspection object; and an image-capturing-movement-control section for controlling at least one of the tilting-holder section and the image-capturing-section-moving mechanism based on the tilting-position-associated information stored in the tilt-position-storage section and the information associated with the line of sight detected by the section for detecting the information associated with the line of sight, so that the image-capturing-movement-control section is configured to cause correlation between the position of the optical axis of the image-capturing section to be identical with correlation between the position of the line of sight of the inspector and the position of the inspection object; and the image-capturing-movement-control section conducts image-capturing movement for the inspection object.

In this case, if the tilting-position-storing-and-operating section is operated by the inspector, the tilting-position-associated information of the tilting-holder section is stored in the tilt-position-storage section; and the section for detecting the information associated with the line of sight recognizes the operation of the tilting-position-storing-and-operating section and detects the information associated with the line of sight of the inspection object directed to the inspection object. In addition, the image-capturing-movement-control section is configured to cause the correlation between the position of the optical axis of the image-capturing section and the position of the inspection object to be identical with the correlation between the position of the line of sight of the inspector and the position of the inspection object based on the tilting-position-associated information and the information associated with the line of sight of the inspector; therefore, image-capturing movement corresponding to the inspection object can be conducted. Consequently, an image that is substantially identical with the image of the inspection object visually observed by the inspector can be captured when the tilting-position-storing-and-operating section is operated.

### EFFECTS OF THE INVENTION

The present invention can obtain an effect that results associated with the visual inspection can be shared since image data that show the same as a visually observed image is produced and preserved. In addition, an effect of enhancing working efficiency can be obtained since no extra inspection is not necessary for reviewing the inspection results.

### BRIEF DESCRIPTION OF DRAWINGS

FIG. 1 is a plan view showing the configuration of a visual inspection apparatus according to a first embodiment of the present invention.

FIG. 2 is a block diagram showing the configuration of the visual inspection apparatus according to the first embodiment of the present invention.

FIG. 3A is a schematic view for explaining a modified example of the first embodiment.

FIG. 3B is a schematic view for explaining the modified example of the first embodiment.

FIG. 4A is a schematic view for explaining another modified example of the first embodiment.

FIG. 4B is a schematic view for explaining the modified example of FIG. 4A of the first embodiment.

FIG. 5 is a block diagram showing the configuration of a visual inspection apparatus according to a second embodiment of the present invention.

FIG. 6 is a schematic view showing the second embodiment at a time of image-capturing.

FIG. 7A is a schematic view showing the second embodiment at a time of visual observation.

FIG. 7B is a schematic view showing the second embodiment at a time of visual observation.

FIG. 8 is a schematic view showing the configuration of a visual inspection apparatus according to a third embodiment of the present invention.

FIG. 9 is a schematic view for explaining a modified example of the third embodiment.

FIG. 10 is a plan view showing the configuration of a visual inspection apparatus according to a fourth embodiment of the present invention.

FIG. 11 is a block diagram showing the configuration of an inspection section and operation section in the visual inspection apparatus according to the fourth embodiment of the present invention.

FIG. 12 is a block function diagram showing the configuration of a unit for detecting information associated with a line of sight disposed in the visual inspection apparatus according to the fourth embodiment of the present invention.

FIG. 13 is a schematic view for explaining an example of image processing step conducted by the inspector's-image-processing section of the visual inspection apparatus according to the fourth embodiment of the present invention.

FIG. 14 is a flowchart for explaining operations of a macro-inspection conducted by the visual inspection apparatus according to the fourth embodiment of the present invention.

FIG. 15 is a flowchart for explaining operations of a step for detecting the information associated with the line of sight conducted by the visual inspection apparatus according to the fourth embodiment of the present invention.

FIG. 16 is a schematic view showing an example of a reference image showing targets used in a second modified example of the fourth embodiment of the present invention.

FIG. 17 is a plan view showing the configuration of a visual inspection apparatus according to a fifth embodiment of the present invention.

FIG. 18 is a block diagram showing the configuration of an inspection section and an operation section in the visual inspection apparatus according to the fifth embodiment of the present invention.

FIG. 19 is a schematic view showing the correlation between the inspection object and a movable index viewed by the inspector by means of the visual inspection apparatus according to the fifth embodiment of the present invention.

FIG. 20 is a block diagram showing the configuration of an inspection section and an operation section in the visual inspection apparatus according to a sixth embodiment of the present invention.

### DETAILED DESCRIPTION OF THE INVENTION

Embodiments in the best mode of the present invention will be explained in detail with reference to drawings as follows. The same reference numerals are added to the same components in the drawings regardless of the embodiments, and duplicate explanations are omitted.

### First Embodiment

A visual inspection apparatus according to a first embodiment of the present invention will be explained.

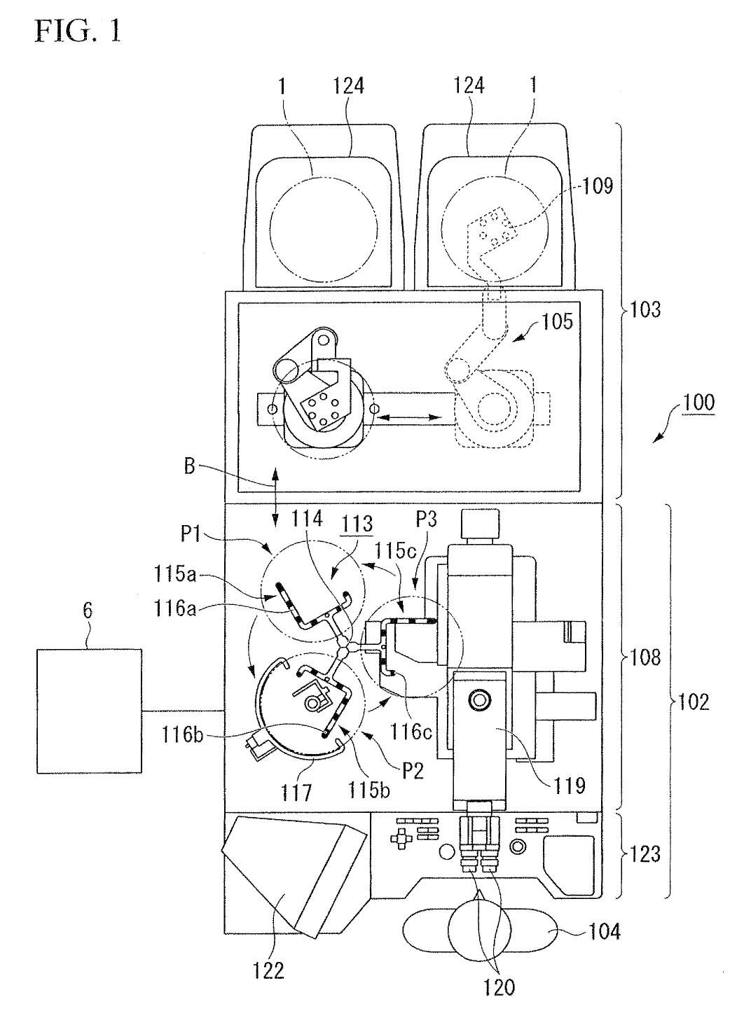

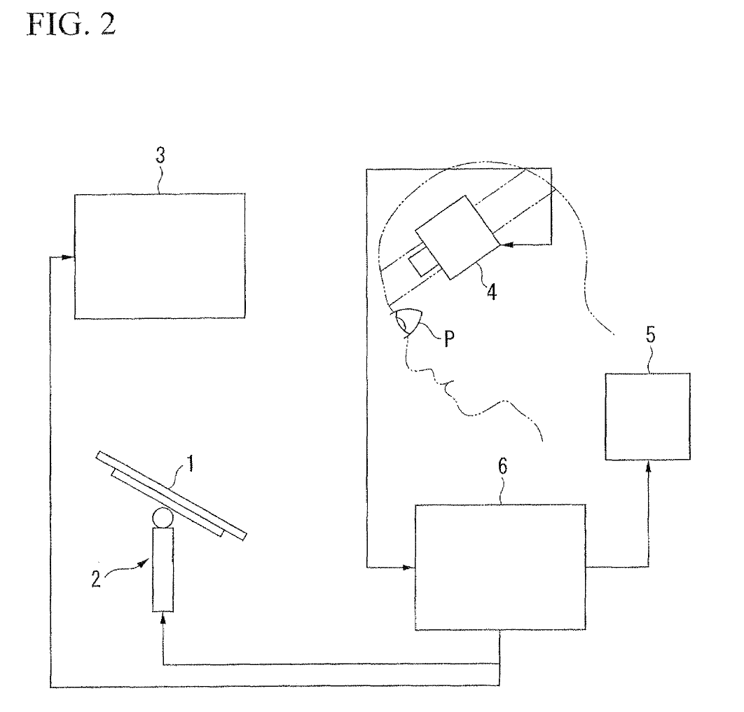

FIG. 1 is a plan view showing the configuration of a visual inspection apparatus according to a first embodiment of the present invention. FIG. 2 is a block diagram showing the configuration of the visual inspection apparatus according to the first embodiment of the present invention.

As shown in FIGS. 1 and 2, a visual inspection apparatus 100 according to the present embodiment is configured to include: an inspection section 102 for conducting macro-inspection and micro-inspection to an inspection object substrate 1 such as a semiconductor wafer; and a loader section 103 for supplying an uninspected substrate 1 to the inspection section 102 and discharging the inspected substrate 1 from the inspection section 102.

The loader section 103 is located in the far side when viewed from the front end (where an inspector 104 conducts inspection) of the inspection section 102. The loader section 103 is provided with a substrate-transfer robot 105. The substrate-transfer robot 105 located in the far side relative to the inspection section 102 is configured to supply a substrate 1 into the inspection section 102 or discharge the substrate 1 from the inspection section 102 (in a direction B as shown in FIG. 1). An enclosure 124 for storing a plurality of substrates 1 is mounted in the far side relative to the substrate-transfer robot 105.

In addition, a substrate-transfer apparatus 113 is provided on the base of the inspection section 102. The substrate-transfer apparatus 113 has three transfer arms 115a, 115b, and 115c disposed at a regular angle (120 degrees). The transfer arms 115a, 115b, and 115c have hands (chucks) 116a, 116b, and 116c respectively. The substrate-transfer apparatus 113 rotates around the rotational axis 114, for example, in counterclockwise direction (in the direction indicated by arrows on the drawing) so that one of the transfer arms 115a, 115b, and 115c is positioned at one of substrate-passing position (position) P1, macro-inspection position (position) P2, and micro-inspection-passing position P3 associated with the substrate-transfer robot 105.

One of the component provided to the macro-inspection section at the macro-inspection position P2 is a carrier base 2 (see FIG. 2) which serves as a macro-inspection-tilting mechanism for conducting a macro-inspection to the surface of the substrate 1 by means of visual inspection of the inspector 104. In addition, a light source 3 (see FIG. 2) is an illuminating apparatus provided above the macro-inspection position P2.

In addition, a micro-inspection section (microscope apparatus 119) is provided on the base of the inspection section 102. The micro-inspection section is allowed to display the image of the substrate 1 magnified by the microscope apparatus 119 and captured by a CCD camera or the like on a monitor 122 (display apparatus 5) or to observe through eyepiece lenses 120.

An operation section 123 provided in front of the inspection section 102 controls the movement of the loader section 103 and the operation of the inspection section 102 that conducts macro-inspection and micro-inspection. The monitor 122 provided at the left hand side of the operation section 123 projects a magnified image of the substrate 1 captured by the microscope apparatus 119 in the micro-inspection.

In addition, a control apparatus 6 provided to the visual inspection apparatus 100 conducts comprehensive control including the movement of the loader section 103; and the macro-inspection and the micro-inspection in the inspection section 102. Functions provided to the control apparatus 6 are, for example, receiving a substrate from or discharging a substrate to the substrate-transfer robot 105, and controlling the substrate-transfer apparatus 113.

An enclosure for storing semiconductor wafers, the micro-inspection section, and a transfer mechanism for transferring the semiconductor wafers are omitted in FIG. 2 that shows components of the visual inspection apparatus 100 that relate to only macro-inspection. Configuration of each component shown in FIG. 2 will be explained as follows.

The substrate 1 is mounted on the carrier base 2 (substrate holder section). The carrier base 2 includes various mechanisms such as: a mechanism for holding the substrate 1 by means of vacuum suction; a mechanism for rotating the substrate 1 in a plane that is parallel with a principal surface of the substrate 1; and a mechanism for arbitrarily varying the angle defined by the principal surface of the substrate 1 and a horizontal plane.

The light source 3 illuminates light onto the surface of the substrate 1. The light source 3 includes a halogen lamp, a fresnel lens, and a liquid-crystal diffuser plate. The liquid-crystal diffuser plate can be a diffuser plate or a transparent plate by turning on or off the power supplied to the liquid-crystal diffuser plate so that the light can be switched between a diffused state and a condensed state. For example, the light source 3 is disposed so that the diffused light or the condensed light can be illuminated onto the substrate 1 in the direction orthogonal to the surface of the substrate 1. An image-capturing apparatus 4 (image-capturing section) including an image-capturing optical system having a function of varying image-capturing magnification ratio and an image-capturing element such as a CCD (charge-coupled-device) or the like. The image-capturing apparatus 4 captures an image of the surface of the substrate 1 and produces image data which form a still image or a moving image. The image-capturing apparatus 4 is disposed in the vicinity of an eye view position P of the inspector. The display apparatus 5 is provided with a monitor or the like, and displays an image captured by the image-capturing apparatus 4.

It should be noted that it is preferable that the image-capturing apparatus 4 have a focal length between 45 mm and 65 mm which corresponds to that of a so-called standard lens based on a 35 mm film format. In addition, it is preferable that the distance between the substrate 1 and the image-capturing apparatus 4 be substantially the same as that between the substrate 1 and the eyes of the inspector. An image visually similar to the inspected object under visual observation can be obtained in this configuration.

The control apparatus 6 (control section) includes a central processing unit (CPU) or the like. The control apparatus 6 controls: rotation and tilt of the substrate 1 by means of the carrier base 2; quantity of light illuminated by the light source 3; image-capturing magnification ratio and image-capturing movement of the image-capturing apparatus 4; and image displayed on the display apparatus 5. In addition, the control apparatus 6 stores the image data, captured by the image-capturing apparatus 4 and correlated with control status obtained when the image was captured, in a storage section, which is not shown in the drawing.

It should be noted that the storage section covers from a long-term information-recordable medium such as hard-disk-recording medium to a temporary information memory medium such as random-access memory (RAM).

The image-capturing apparatus 4 (image-capturing section) is disposed so that relationship associated with the angle defined by the light source 3, the substrate 1, and a line of sight under visual observation is substantially the same as that associated with the angle defined by the light source 3, substrate 1, and the optical axis of the image-capturing apparatus 4. In other words, an image can be produced that is substantially identical with an image conceived by the inspector since the image-capturing apparatus 4 is disposed in the vicinity of the eye view position P (that is the view point of the inspector) of the inspector so that the optical axis of the image-capturing apparatus 4 substantially coincides with the line of sight of the inspector who observes the substrate 1 during visual inspection, i.e., so that image-capturing direction substantially coincides with the eye view direction. In order to obtain an image that is identical with a visually-observed image of the inspector, it is preferable that the position of the image-capturing apparatus 4 is as close as possible to the position of the eye view position P and that image-capturing direction of the image-capturing apparatus 4 coincide with the eye view direction of the inspector. In order to dispose the position of the image-capturing apparatus 4 as close as possible to the position of the eye view position P, the image-capturing apparatus 4 may be attached to one of the eyes of the inspector 104 or to the vicinity of the eye by, for example, attaching the image-capturing apparatus 4 to a head part (a center or the like of forehead) of the inspector 104, or, by placing the image-capturing apparatus 4 to a frame or a lens part of glasses worn by the inspector. For example, FIG. 2 shows the image-capturing apparatus 4 attached to a temple.

Also, operations for substantially coinciding the image-capturing direction of the image-capturing apparatus 4 with the eye view direction of the inspector may be adjusting of the position of the image-capturing apparatus 4 by observing the image displayed on the display apparatus 5 so that a visually obtained image coincides with the displayed image. Alternatively, the image visually observed by the inspector may be identical with the image captured by the image-capturing apparatus 4 by attaching a head-mount goggle display onto an eye section of the inspector and displaying the image of the substrate 1 captured by the image-capturing apparatus 4 on the head-mount display.

Operations conducted by each component during macro-inspection will be explained next. The control apparatus 6 during inspection conducts various settings for the carrier base 2, the light source 3, and the image-capturing apparatus 4. That is, the control apparatus 6 puts out a signal to the carrier base 2 so that the signal provides instructions that the substrate 1 be tilted and supported with an angle relative to the horizontal plane based on a signal put out by the operation section 123 indicative of the operations conducted by the inspector or on preset information. The carrier base 2 supports the substrate 1 at the instructed angle based on the signal. In a case of inspecting the substrate 1 while being rotated, the control apparatus 6 puts out a signal to the carrier base 2 so that the signal indicates start of rotation, rotation speed, and direction of rotation etc. The carrier base 2 rotates the substrate 1 in the plane that is parallel with its principal surface based on the signal. In addition, the control apparatus 6 puts out a signal, which provides instruction for setting quantity of light etc., to the light source 3. Light illuminated by the light source 3 onto the substrate 1 based on the signal having predetermined quantity of light and wavelength may be diffused light, condensed light, or the like.

In addition, the control apparatus 6 puts out a signal, which indicates settings for image-capturing conditions or the like, to the image-capturing apparatus 4. The image-capturing apparatus 4 sets image-capturing magnification ratio etc. based on the signal. Subsequently, the control apparatus 6 puts out a signal, which provides instruction for capturing an image, to the image-capturing apparatus 4. The image-capturing apparatus 4 upon capturing an image of a surface of the substrate 1 based on the signal produces image data and puts them out to the control apparatus 6. The control apparatus 6, upon storing the image data in the internally-disposed storage section, retrieves the image data from the storage section at predetermined timing and puts them out to the display apparatus 5. The display apparatus 5 displays the image based on the image data. A moving image is displayed on the display apparatus 5 by repeating the aforementioned operations. That is, the image-capturing apparatus 4 continuously produces image data that constitute a moving image, and puts them out to the control apparatus 6. The control apparatus 6 puts out the image data, put out from the image-capturing apparatus 4, to the display apparatus 5 sequentially. The display apparatus 5 displays the moving image based on the image data put out sequentially from the control apparatus 6.

The inspector captures an image, and simultaneously, conducts visual inspection for the substrate 1. A signal indicative of the result of operation conducted to the joystick or the like by the inspector is put into the control apparatus 6 from the operation section 123. The control apparatus 6 puts out a signal, which indicates tilting of the substrate 1 (variation in direction and angle of tilting), to the carrier base 2 based on the signal put into the control apparatus 6. The carrier base 2 tilts the substrate 1 based on the signal.

The inspector upon finding a defect by visual observation presses down a switch or the like on the operation section 123 to store an image showing the current state of defect. The operation section 123 puts out a signal indicative of the operation conducted to the switch or the like to the control apparatus 6. The control apparatus 6 upon detecting the signal put out to the control apparatus 6 stores the still image data that are put out from the image-capturing apparatus 4 and indicative of an inspection result into the internally-disposed storage section. When an instruction for displaying the inspection result is provided via the operation section 123 after the end of inspection, the control apparatus 6 retrieves the image data from the internally-disposed storage section and puts them out to the display apparatus 5. The display apparatus 5 displays the image based on the retrieved image data. Accordingly, the image visually observed during inspection can be reviewed after the inspection.

It should be noted that the inspector observing the image displayed on the display apparatus 5 during an inspection may conduct operation, for example, adjusting of the position of the image-capturing apparatus 4 if a visually observed image differs from the displayed image significantly. Alternatively, inspection results to be stored may be motion image data in place of only specific still image data. In addition, the image-capturing apparatus 4 may capture only a still image so that the image-capturing apparatus 4 puts out a currently-obtained still image to the control apparatus 6 only when the image-capturing apparatus 4 receives an instruction from the control apparatus 6 based on an instruction provided by the inspector to capture an image.

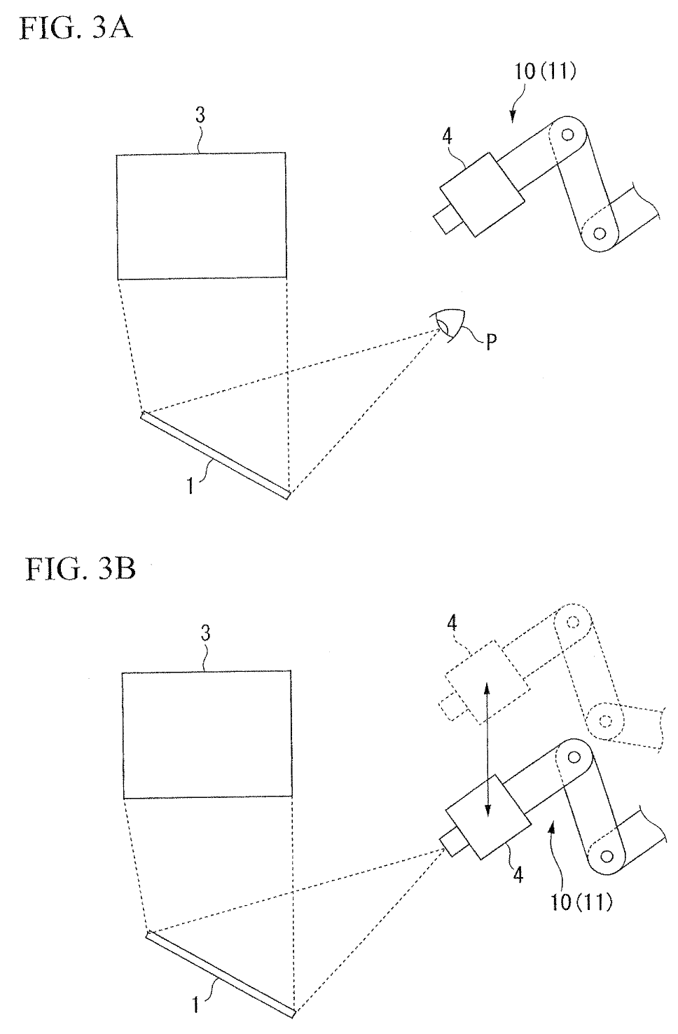

A modified example of the present embodiment will be explained next. As shown in FIGS. 3A and 3B, the image-capturing apparatus 4 is retracted to a position where observation is not interfered (see FIG. 3A) during visual observation for the substrate 1, and the image-capturing apparatus 4 is moved to the same position as or to the vicinity of the eye view position P during image-capturing (see FIG. 3B).

An image-capturing-holder section 10 supports and moves the image-capturing apparatus 4, and fixes the image-capturing apparatus 4 at a predetermined position during visual observation and image-capturing. The image-capturing-holder section 10 can be realized, for example, by attaching the image-capturing apparatus 4 onto a rail that can transfer an object in an axial direction and sliding the image-capturing apparatus 4 vertically or horizontally. Alternatively, as shown in FIGS. 3A and 3B, the image-capturing apparatus 4 may be attached onto a freely extendable arm 11 so that the image-capturing apparatus 4 is moved by the arm 11.

Also alternatively, the image-capturing apparatus 4 may be moved by using a mechanism provided with a multi-articulation mechanism having a plurality of arms.

The movement of the image-capturing-holder section 10 is controlled by the control apparatus 6. That is, the control apparatus 6 puts out a signal, which indicates the retraction of the image-capturing apparatus 4, to the image-capturing-holder section 10 when the image-capturing apparatus 4 is disposed on an image-capturing position as shown in FIG. 3B during visual observation conducted by the inspector who observes the substrate 1. The image-capturing-holder section 10 moves the image-capturing apparatus 4 to a position which does not interfere the observation based on the signal indicative of the retraction of the image-capturing apparatus 4. In addition, the control apparatus 6 upon detecting the instruction for capturing an image provided by the inspector puts out a signal, which indicates moving of the image-capturing apparatus 4 to the image-capturing position based on the instruction to the image-capturing-holder section 10. The image-capturing-holder section 10 moves the image-capturing apparatus 4 to the position that is identical with or in the vicinity of the eye view position P based on the signal put out to the image-capturing-holder section 10.

A visually observed image may be identical with an image produced by the image-capturing apparatus 4 (i.e. the eye view position P is identical with the position of the image-capturing apparatus 4 during image-capturing, and the eye view direction is identical with the direction for capturing an image by the image-capturing apparatus 4) as follows. For example, the image-capturing apparatus 4 during image-capturing is fixed, and the eye view position P is identical with the fixed image-capturing apparatus 4. In this case, a sight for visual observation is provided to fix the position of the eye view position P. For example, a cross marking is provided to each one of two glass plates (reticle plates), and the glass plates are separated by a distance in a direction orthogonal to each principal surface of the glass plate.

Alternatively, for example, the height of the image-capturing apparatus 4 may be set based on the height of the inspector and a previously obtained correlation between the height (height or sitting height) of the inspector and height of the image-capturing apparatus 4. The image-capturing direction of the image-capturing apparatus 4 is also preset in accordance with the aforementioned eye view direction. The present modified example allows the inspector to conduct visual inspection for the substrate 1 without concerning for the image-capturing apparatus 4 during visual observation.

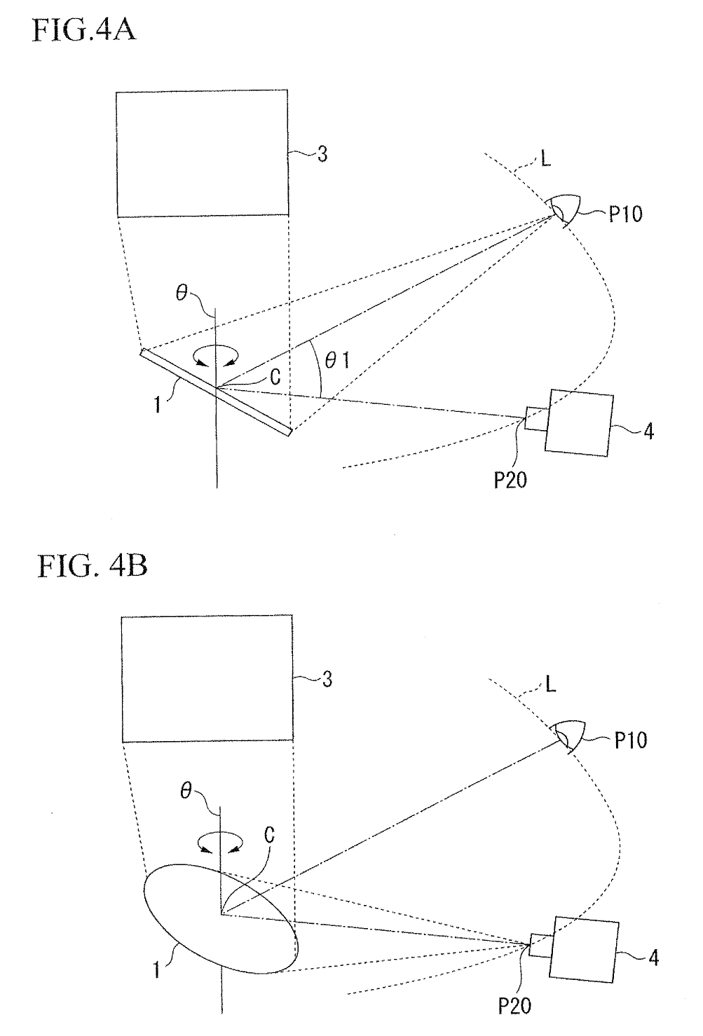

Another modified example of the present embodiment will be explained next. As shown in FIGS. 4A and 4b, eye view position P10 (view point position of the inspector) and position P20 of the image-capturing apparatus 4 (for example, the center of an image-capturing surface of an image-capturing element provided to the image-capturing apparatus 4) are fixed. An angle defined by a reference axis (for example, an axis connecting the eye view position P10 and center position C of the substrate 1) extending in the eye view direction and a horizontal plane is set to be equal to an angle defined by a reference axis (for example, an axis directed toward the center position C of the substrate 1 of an image-capturing optical system provided to the image-capturing apparatus 4) extending in the image-capturing direction of the image-capturing apparatus 4 and the horizontal plane. In addition, the height of the position P20 of the image-capturing apparatus 4 and the height of the eye view position P10 are equal from an arbitrary reference horizontal plane and disposed on a contour line L which is defined by connecting points that have an identical distance from the center position C of the contour line L. In addition, the substrate 1 is rotatable (movable rotationally) around a rotational axis θ extending in the vertical direction and passing through the center position C of the substrate 1 while the carrier base 2 maintains the angle defined by the principal surface and the horizontal plane.

The dispositions of the substrate 1, the light source 3, the eye view position P10 of the inspector, and the image-capturing apparatus 4 may be controlled so that the following correlations relative to each other are satisfied.

In the beginning, three angles defined by three directions including the direction of the axis of the light illuminated by the light source 3 (illuminating section) toward the center position C of the substrate 1 during visual observation; the direction of a normal of the substrate 1; and the direction of the reference axis extending from the center position C of the substrate 1 in the inspector's eye view direction are identical respectively with three angles defined by three directions including the direction of the axis of the light illuminated by the light source 3 toward the center position C of the substrate 1 during image-capturing conducted by the image-capturing apparatus 4; the direction of a normal of the substrate 1; and the direction of the optical axis of the image-capturing optical system of the image-capturing apparatus 4 directed toward the center position C of the substrate 1. Subsequently, the correlation among the light source 3, the center position C of the substrate 1 and the eye view position P10 during visual observation is identical respectively with the correlation among the light source 3, the center position C of the substrate 1, and the position of the image-capturing apparatus 4 during image-capturing conducted by the image-capturing apparatus 4. That is, components are disposed in each correlation so that the correlation under visual observation is rotatable around the center position C to coincide with the correlation during image-capturing.

Therefore, the position P20 of the image-capturing apparatus 4 and the eye view position P10 may not have to be on the contour line L if a rotational movement apparatus that can freely rotate around the center position C is provided to the light source 3. That is, the carrier base 2 may be rotated or tilted during image-capturing so that the correlation among positions of the light source 3, the principal surface of the substrate 1, and the eye view position P10, and the relationships among the axis of light directed to the center position C from the light source 3, the reference axis extending in the eye view direction, and the normal of the principal surface of the substrate 1 can be maintained and converted to correlation among the positions of the light source 3, the principal surface of the substrate 1, and the image-capturing apparatus 4, and the relationships among the axis of light directed toward the center position C from the optical axis, the optical axis of the image-capturing optical system directed toward the center position C, and the axis of the normal of the principal surface of the substrate 1.

The carrier base 2 is further controlled so that the rotational angle of the substrate 1 around the normal on the center position C maintain the correlation between visual observation and the capturing of an image. In this configuration, an orthoscopic image can be obtained in visual observation and image-capturing. In addition, a similar image can be obtained in visual observation and image-capturing in order to observe diffraction light based on a pattern formed on the substrate 1.

Here, θ1 is an angle defined by a line segment connecting the eye view position P10 and the center position C of the substrate 1 and a line connecting the position P20 of the image-capturing apparatus 4 and the center position C of the substrate 1. In addition, information associated with the eye view position P10, the position P20 of the image-capturing apparatus 4, and the angle θ1 are stored in the storage section of the control apparatus 6.

Firstly, the inspector conducts visual observation as shown in FIG. 4A. The reference axis extending in the eye view direction is defined by reticle plates or the like. Subsequently, the inspector in an attempt to store an image of the visually observed image presses down a switch or the like, not shown in the drawing, of the operation section.

The operation section 123 puts out a signal indicative of the operation conducted to the switch or the like to the control apparatus 6. The control apparatus 6 upon detecting the signal puts out a signal which indicates rotation of the substrate 1 by angle θ1 to the carrier base 2. The carrier base 2 rotates the substrate 1 by angle θ1 around the rotational axis θ in a direction directed toward the position P20 of the image-capturing apparatus 4 from the eye view position P10 based on the signal (see FIG. 4B). Subsequently, the image-capturing apparatus 4 upon capturing an image of the surface of the substrate 1 produces and puts out image data to the control apparatus 6. The control apparatus 6 stores the image data in the internally-disposed storage section.

It should be noted that the light source 3 illuminates light onto the substrate 1 in the vertical direction (or in a direction parallel with the rotational axis θ) in order to coincide the visually observed image with the image produced by the image-capturing apparatus 4. In addition, it is preferable that the central position of the light illuminated by the light source 3 coincides with the center position C of the substrate 1. According to the present modified example, an image that is identical with the visually observed image when the image-capturing apparatus 4 cannot be disposed at the eye view position.

In addition, it is preferable that the image-capturing apparatus 4 is disposed at a position which does not interfere observation for the substrate during visual observation. In particular, it is preferable that the image-capturing apparatus 4 is disposed in the back side to the observer relative to the rotational axis 114 of the substrate-transfer apparatus 113.

As aforementioned, inspection results obtained under visual inspection can be shared in the present embodiment since image data that are identical with visually observed image are produced and preserved (stored). In addition, an extra inspection is not necessary since the results associated with visual inspection may be reviewed by, for example, displaying the stored image data; therefore, efficiency of operation can be enhanced.

### Second Embodiment

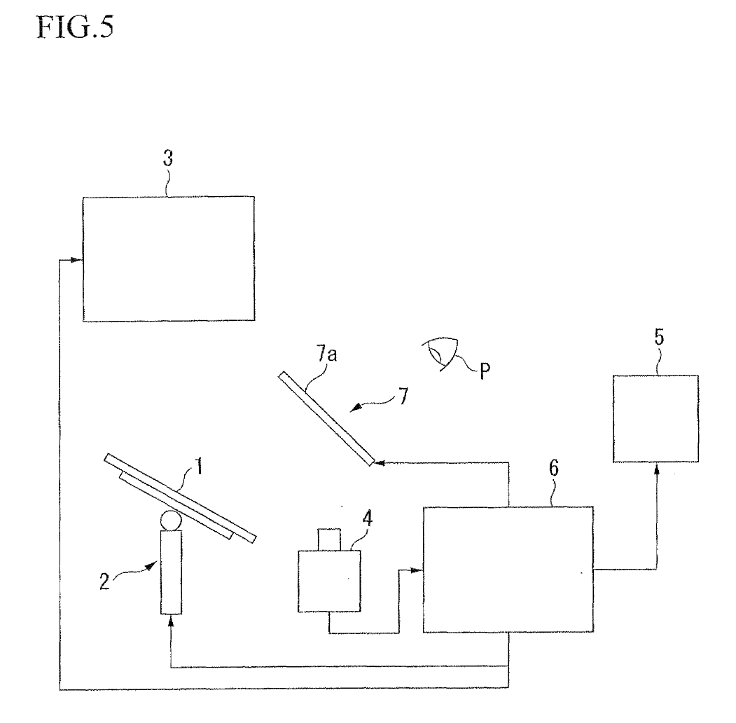

A second embodiment of the present invention will be explained next. FIG. 5 is a block diagram showing the configuration of a visual inspection apparatus according to the present embodiment.

In the present embodiment, a mirror section 7 (reflective-plate holder section) provided between the substrate 1 and the eye view position P includes a mirror 7a (light-reflective plate) for reflecting light illuminated by the light source 3 and diffused or diffracted by the substrate 1. The mirror section 7 is provided with a mechanism for rotating the mirror 7a around an end the mirror section 7, or for moving the mirror 7a in parallel with the vertical plane or the horizontal plane. The mechanism for rotating or moving parallel the mirror 7a may be formed by a multi-articulation mechanism having a plurality of arms, a rail that can transfer an object unidirectionally, or a freely extendable arm as previously explained with respect to the first embodiment.

The image-capturing apparatus 4 is disposed via the mirror 7a of the mirror section 7 at a position that can act as substantially the same as the eye view position P. The position that acts substantially the same as the eye view position P allows an image visually observed from the eye view position P to become identical with an image based on light which is diffused or diffracted by the substrate 1, reflected by the mirror 7a, and is incident into the image-capturing apparatus 4. In other words, the image-capturing apparatus 4 is disposed previously at a predetermined position, and the mirror section 7 during image-capturing disposes the mirror 7a at a position so that an image visually observed by the inspector is identical with an image produced based on light incident into the image-capturing apparatus 4.

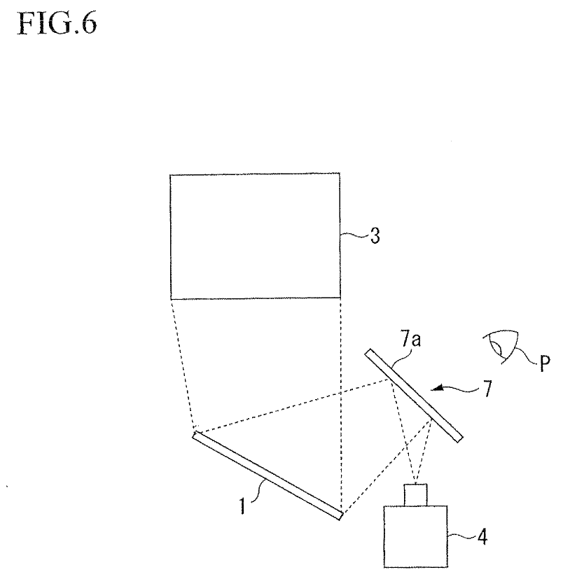

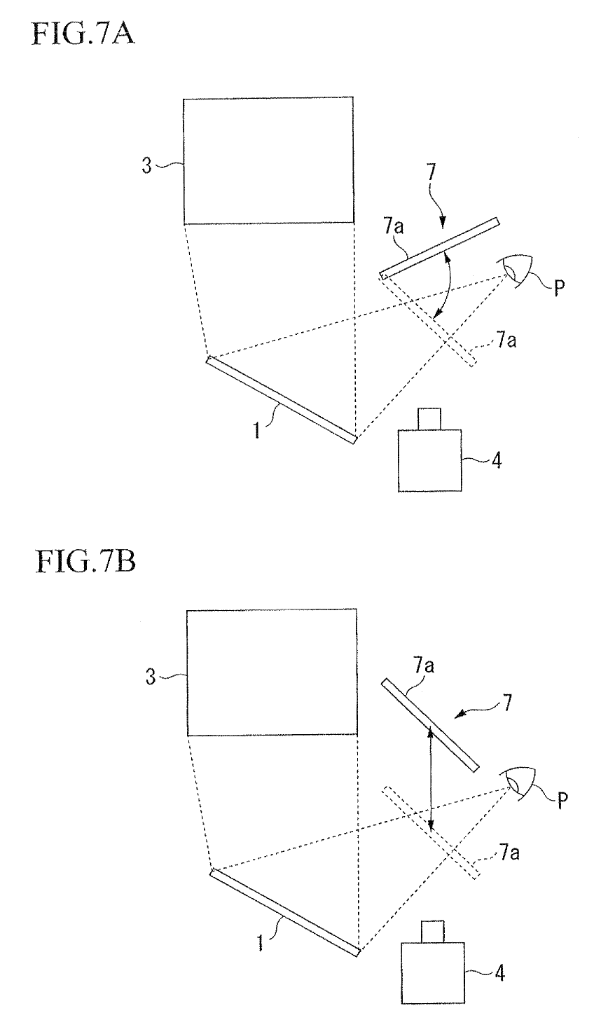

As shown in FIG. 6, the mirror 7a during image-capturing is disposed between the substrate 1 and the eye view position P, and the image-capturing apparatus 4 captures an image produced based on light reflected by the mirror 7a. The image data produced by the image-capturing apparatus 4 during image-capturing is put out to the control apparatus 6 and stored in the internally-disposed storage section. On the other hand, during visual observation with eyes, the control apparatus 6 puts out a signal to the mirror section 7 which indicates moving of the mirror 7a. The mirror section 7 retracts the mirror 7a (see FIG. 7A) to a position which does not interfere observation so that light coming from the substrate 1 reaches to the eyes of the inspector directly and so that the inspector can conduct visual observation for the substrate 1 by driving a motor or the like, which is not shown in the drawings, based on the received signal and rotating the mirror 7a around an end of the mirror section 7.

Alternatively, the mirror section 7 retracts the mirror 7a to a position which does not interfere with observation so that light coming from the substrate 1 reaches to the eyes of the inspector directly and so that the inspector can conduct visual observation for the substrate 1 by driving the motor or the like, which is not shown in the drawings, based on the signal received from the control apparatus 6 and moving the mirror 7a in parallel with the vertical plane or the horizontal plane. The control apparatus 6 in an attempt to capture an image of a defect, found by the inspector, based on an instruction provided by the inspector puts out a signal, which indicates moving of the mirror 7a, to the mirror section 7. The mirror section 7 moves the mirror 7a to a predetermined image-capturing position by rotating the mirror 7a or moving the mirror 7a in parallel with the vertical plane or the horizontal plane based on the signal provided by the control apparatus 6.

In the present embodiment, it is preferable that the eye view position P be fixed. For that purpose, for example, a sight may be provided for fixing the eye view position P as previously explained with respect to the first embodiment. Alternatively, the eye view position may be determined so that an image displayed by the display apparatus 5 coincides with a visually observed image by fixing correlation between the image-capturing apparatus 4 and the mirror 7a during image-capturing; displaying the image captured by the image-capturing apparatus 4 in a display apparatus 5; switching the orientation of the mirror 7a several times as shown in FIGS. 6 and 7A, or in FIGS. 6 and 7B; and shifting the eye view position while observing the image displayed by the display apparatus 5.

In addition, in order to determine the correlation between the mirror 7a and the image-capturing apparatus 4 during image-capturing, the position of the mirror 7a may be determined so that an image displayed by the display apparatus 5 coincides with a visually observed image by fixing the eye view position P and the position of the image-capturing apparatus 4; switching the orientation of the mirror section 7 several times as shown in FIGS. 6 and 7A or in FIGS. 6 and 7B; and changing the position (including the angle) of the mirror 7a while observing the image displayed by the display apparatus 5. Alternatively, the position of the image-capturing apparatus 4 may be determined so that the image displayed by the display apparatus 5 coincides with the visually observed image by fixing the eye view position P and the position of the mirror 7a; switching the orientation of the mirror section 7 several times as shown in FIGS. 6 and 7A or in FIGS. 6 and 7B; and changing the position of the image-capturing apparatus 4 while observing the image displayed by the display apparatus 5.

The present embodiment can achieve the effect similar to that of the first embodiment. In addition, an image which is identical with the visually observed image can be obtained in a case of failing to dispose the image-capturing apparatus 4 at a position as shown in the first embodiment (i.e., a point to which light coming from the substrate 1 reaches not via a reflective plate).

### Third Embodiment

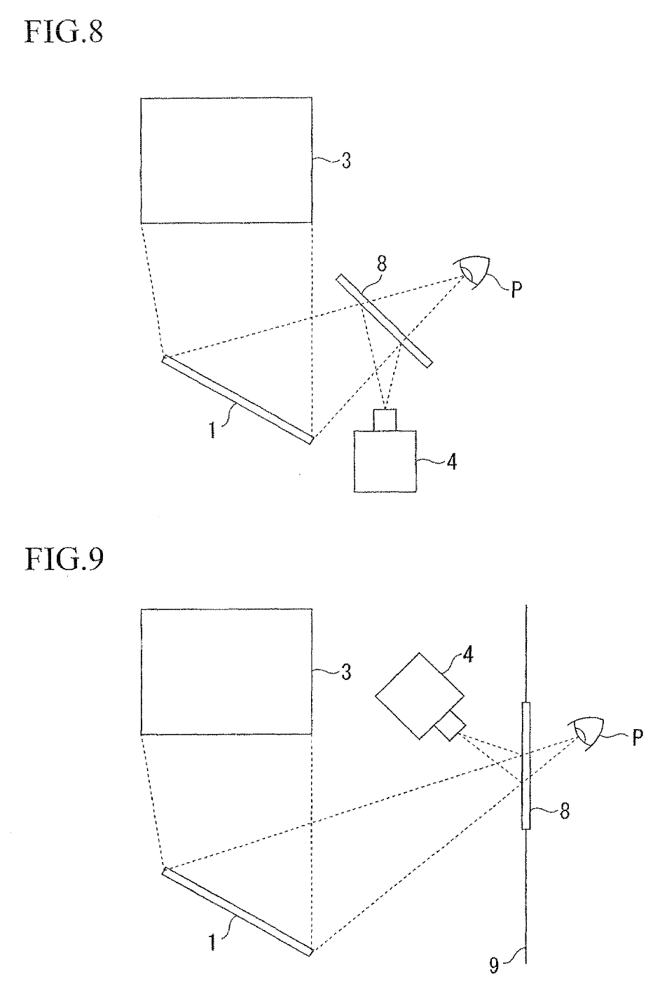

A third embodiment of the present invention will be explained next. As shown in FIG. 8, a half mirror 8 (translucent reflective plate) is provided between the substrate 1 and the eye view position P in the present embodiment. The half mirror 8 is provided with a function of transmitting light diffused or diffracted by the substrate 1 therethrough and a function of reflecting the light diffused or diffracted by the substrate 1. The light transmitted through the half mirror 8 and reached to the eyes of the inspector located at the eye view position P is recognized by the inspector as representing the image of the surface of the substrate 1. In addition, the light reflected by the half mirror 8 is incident into the image-capturing apparatus 4. Similarly to the second embodiment, the image-capturing apparatus 4 is disposed via the half mirror 8 at a position that can act as substantially the same as the eye view position P. It should be noted that the image-capturing apparatus 4 disposed beneath the half mirror 8 while having the image-capturing surface upwardly as shown in FIG. 8 may be disposed above the half mirror 8 while having the image-capturing surface downwardly.

Operations in the present embodiment are similar to those in the first embodiment. That is, image data produced by the image-capturing apparatus 4 are put out to the control apparatus 6 and stored in the internally-disposed storage section. In addition, the image data retrieved from the storage section and put out to the display apparatus 5 are displayed by the display apparatus 5. The inspector checks for a defect while tilting or moving the substrate 1. In order to store the image data corresponding to a defect found by the inspector, the control apparatus 6 stores the image data put out from the image-capturing apparatus 4 into the storage section based on an instruction provided by an inspector. In addition, the eye view position P, the position of the image-capturing apparatus 4, and the position of the half mirror 8 may be determined similarly to the second embodiment.

A modified example of the present embodiment will be explained next. As shown in FIG. 9, a partition member 9 is provided for separating the visual inspection apparatus and the inspector. The partition member 9 is provided for preventing some pollutant including various kinds of vapor, grain, and particle, that are discharged from the inspector from drifting in atmosphere and flowing toward the substrate 1 in the shortest distance during inspection. The partition member 9 has an opening section provided on a part of the partition member 9, and the half mirror 8 is disposed in the opening section. That is, the half mirror 8 has an additional role as an observation window used for observing the substrate 1.

It should be noted that a partition member called as a mini-environment may surround the visual inspection apparatus 100 except for the movable sections of the substrate-transfer robot 105 of the loader section 103 of the visual inspection apparatus 100 as shown in FIG. 1; the monitor 122 and the operation section 123 of the inspection section 102; and the eyepiece lenses 120 of the microscope apparatus 119.

In this configuration, minute foreign affairs produced in the visual inspection apparatus may be fell down to be ejected into the exterior of the apparatus by disposing the partition member 9 in the visual inspection apparatus; disposing a filter fan unit (FFU) onto the upper section of the partition member 9; and introducing air having a high degree of cleanliness into the visual inspection apparatus. That is, the partition member 9 is formed to not only separate the visual inspection apparatus and the inspector but also to fully cover the visual inspection apparatus. In addition, a transparent plate may be disposed in the opening section of the partition member 9, and the half mirror 8 may be provided in the exterior of the partition member 9.

The present embodiment can achieve the effect similar to that of the first embodiment. In addition, a more simple structure relative to that of the second embodiment can be achieved since a rotative mechanism or a movable mechanism for the mirror 7a can be omitted if the half mirror 8 is provided in place of the mirror 7a.

In addition, it should be noted that a prism or a band-pass-filter may be used in place of the mirror 7a or the half mirror 8. In addition, it is preferable that the visually observed image be substantially identical with the image captured by the image-capturing apparatus 4 in the aforementioned embodiments. The description of “substantially identical” means that two images are regarded as identical if the type and position of a defect are considered to be identical between two images. For example, two images that can be looked differently in accordance with the image-capturing magnification ratio of the image-capturing apparatus 4 are not considered to be different from each other.

### Fourth Embodiment

A visual inspection apparatus according to a fourth embodiment of the present invention will be explained.

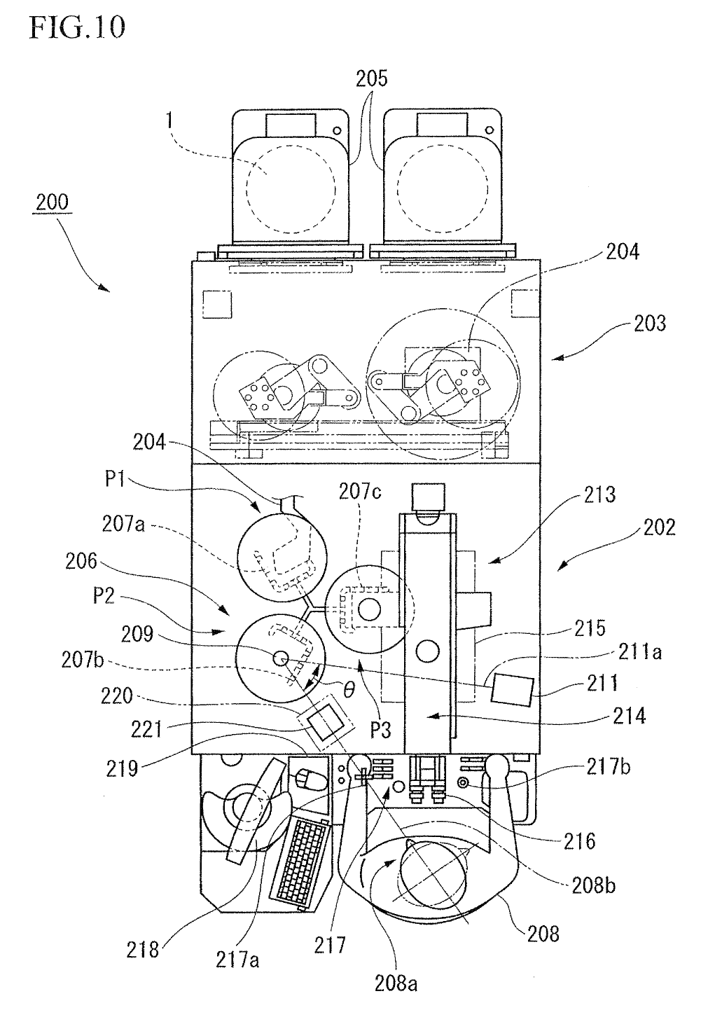

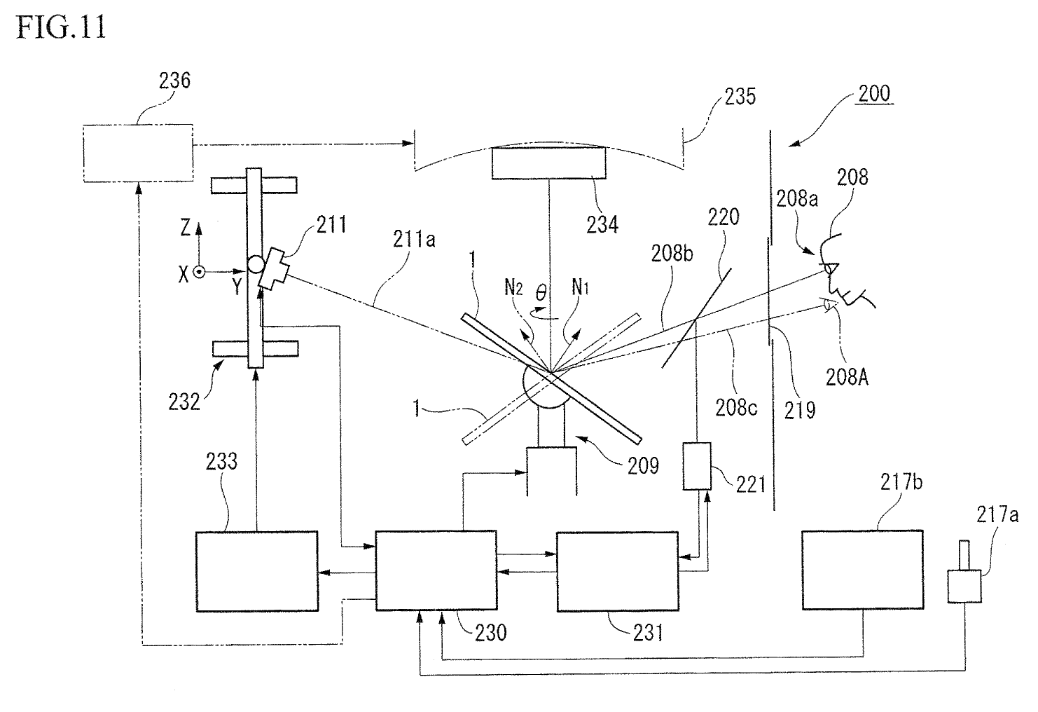

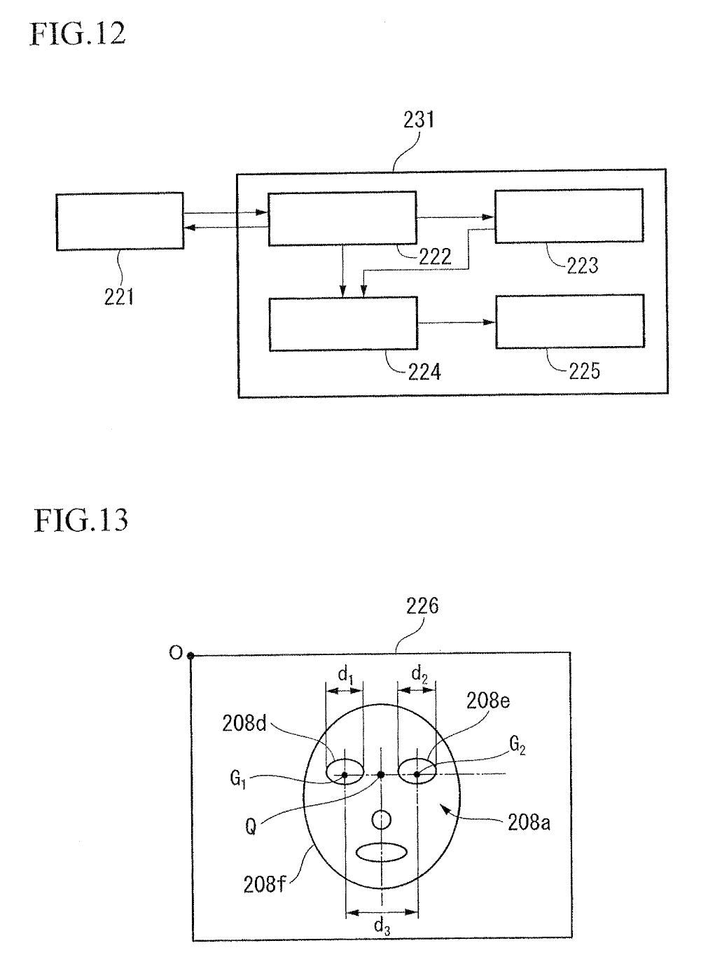

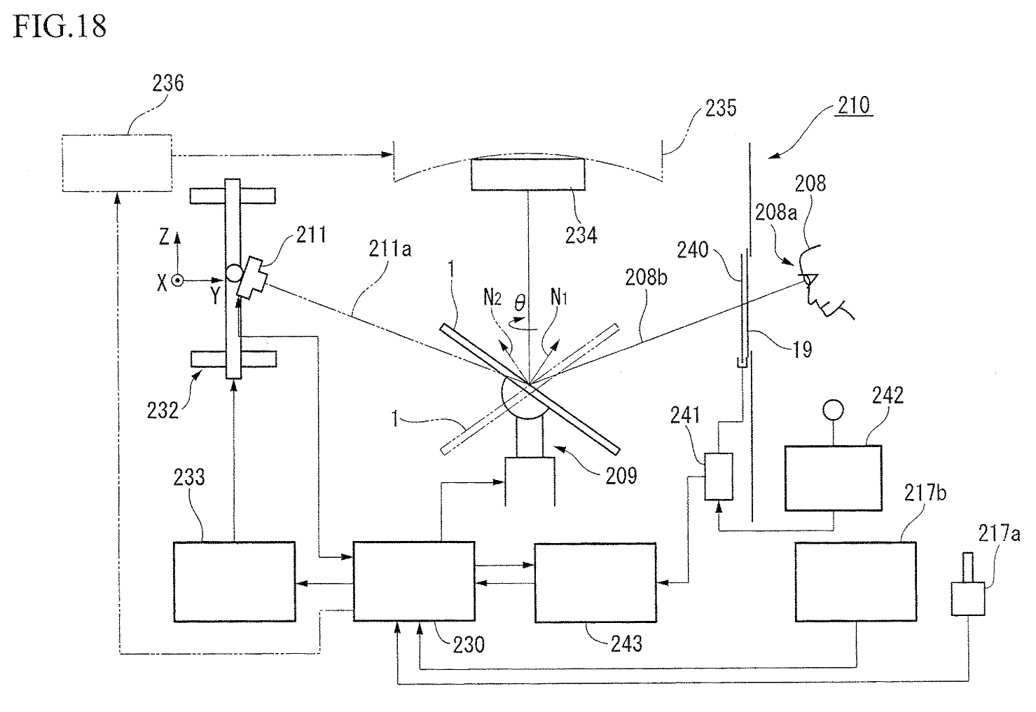

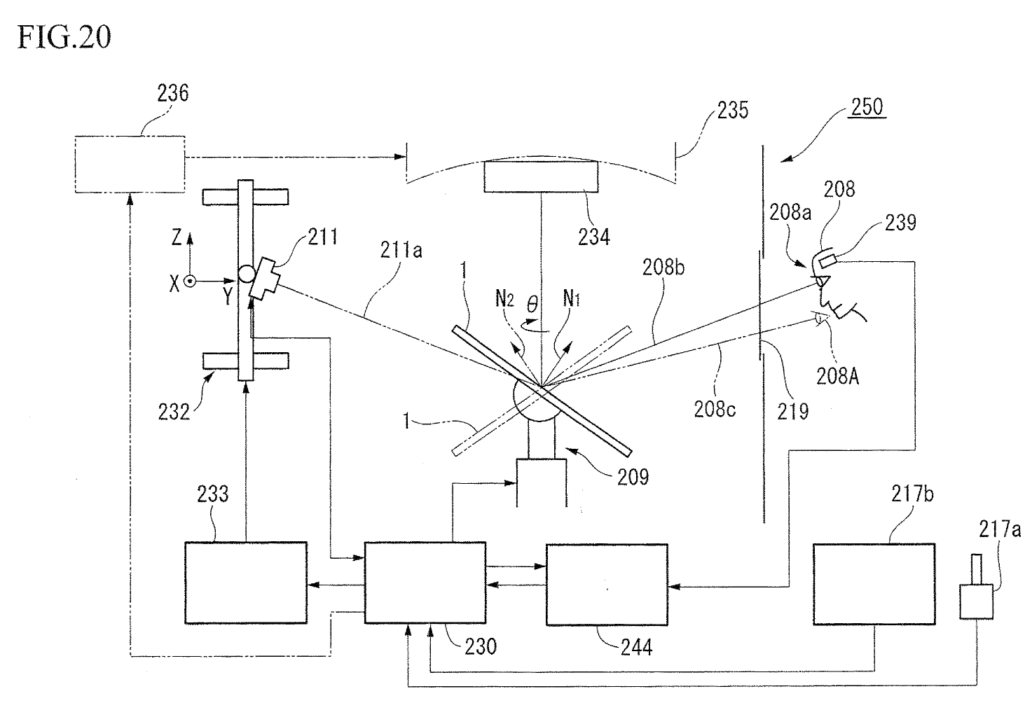

FIG. 10 is a plan view showing the configuration of a visual inspection apparatus according to a fourth embodiment of the present invention. FIG. 11 is a block diagram showing the configuration of an inspection section and an operation section in the visual inspection apparatus according to a sixth embodiment of the present invention. FIG. 12 is a block function diagram showing the configuration of a unit for detecting information associated with a line of sight disposed in the visual inspection apparatus according to the fourth embodiment of the present invention. FIG. 13 is a schematic view for explaining an example of image processing step conducted by the inspector's-image-processing section of the visual inspection apparatus according to the fourth embodiment of the present invention. It should be noted that FIG. 11 is the schematic view that shows components in partly deployed state, and the relationship of projected light with the components may not be precise. (This applies to FIGS. 18 and 20). A visual inspection apparatus 200 provided in the present embodiment illuminates light onto the inspection object substrate 1 and checks for defect including, for example, surface flaw, adhesion of dust, faulty deposition thickness and searches for the position thereof. FIG. 10 shows the general configuration of the visual inspection apparatus 200 which includes a transfer section 203, an inspection section 202, and an operation section 217.

The transfer section 203 is provided for supplying an uninspected substrate 1, which is previously set in an enclosure 205, to the inspection section 202 and discharges a substrate 1 inspected by the inspection section 202 to the enclosure 205. The transfer section 203 is provided with a substrate-transfer robot 204 for transferring the substrate 1 between the enclosure 205 and the inspection section 202.

The inspection section 202 is configured to conduct macro-inspection that allows an inspector 208 to conduct visual inspection by tilting the substrate 1 supplied by the transfer section 203 and illuminating light onto the substrate 1; and micro-inspection in which the surface of the substrate 1 undergoes microscopic observation.

FIGS. 10 and 11 show the general configuration of the inspection section 202 including: a rotative transfer mechanism 206; a macro-inspection-tilting mechanism 209 (tilting-holder section); a illuminating section 234; a camera 211 (image-capturing section); an inspector's-image-capturing camera 221 (inspector's-image-capturing section); a unit 231 for detecting information associated with the line of sight (inspector's-image-processing section); a control unit 230; and a micro-inspection section 213.

The rotative transfer mechanism 206 is a mechanism for rotating and transferring the substrate 1 among predetermined transfer positions provided at a regular angular pitch in the horizontal plane.

The transfer positions set in the present embodiment at a regular angular pitch of 120 degrees on a common circle include: substrate-passing position P1 for receiving the substrate 1 from the substrate-transfer robot 204 or passing the substrate 1 to the substrate-transfer robot 204; macro-inspection position P2 for setting the substrate 1 to which macro-inspection will be conducted, in the macro-inspection-tilting mechanism 209 which tilts the substrate 1; and micro-inspection-passing position P3 for passing the substrate 1, to which micro-inspection will be conducted, to the micro-inspection section 213. For example, the substrate-passing position P1 is disposed in the vicinity of the transfer section 203; the macro-inspection position P2 is disposed in the vicinity of the operation section 217; and the micro-inspection-passing position P3 is disposed in the middle of the substrate-passing position P1 and the macro-inspection position P2 as shown in FIG. 10.

In addition, the rotative transfer mechanism 206 is configured to adopt three transfer arms 207a, 207b, and 207c for holding the substrate 1 by means of suctioning so that the arms extend in radial directions that are equally divided by 120 degrees with respect to the rotational axis provided on the center of a circle on which the transfer positions are disposed.

The macro-inspection-tilting mechanism 209 moving up and down in the center of the macro-inspection position P2 holds the center of the substrate 1, transferred to the macro-inspection position P2, by means of suctioning for tilting the substrate 1.

The tilting movement of the macro-inspection-tilting mechanism 209 is conducted by the manipulation of the inspector 208 provided via the operation section 217 or controlled by the control unit 230 based on pre-stored data associated with the tilting movement.

In the present embodiment, the illuminating section 234 provided above the macro-inspection-tilting mechanism 209 is configured to be able to illuminate light fully onto the substrate 1. It is preferable that, the illumination of light can be switched between a substantially condensed state and an appropriately diffused state if necessary.

The camera 211 is provided for obtaining a visible image of the substrate 1 by capturing an image of the substrate 1 held by the macro-inspection-tilting mechanism 209. According to the present embodiment adopting a CCD camera, an obtained visible image can be sent to the control unit 230 and displayed on a monitor 218 or stored in a storage section, for example, a harddisk or the like.

In addition, as shown in FIG. 10, the camera 211 is supported movably by a camera-moving mechanism 232 (image-capturing-section-moving mechanism) in plan view at a position rotated by angle θ relative to the standard direction of a line of sight of the inspector 208 who observes the substrate 1.

As shown in FIG. 11, the camera-moving mechanism 232 is a mechanism for disposing the camera 211 based on the tilting position of the macro-inspection-tilting mechanism 209 at a position which can obtain a result that is equivalent to visual observation for the substrate 1 conducted by the inspector 208. An adoptable configuration therefor may be, for example, a mechanism formed by assembling an XYZ-axis stage and 2-axes-rotation stage.

However, the camera-moving mechanism 232 is not limited to the aforementioned configuration as long as the camera-moving mechanism 232 is provided with a freedom of movement that is necessary to move the view point or reproduce the line of sight during inspection under visual observation in the macro-inspection by the inspector 208. An adoptable example thereof may be a combination of rotational movement of the macro-inspection-tilting mechanism 209 around the vertical axis that passes through the center of the tilting movement; the movement in the vertical direction; and the rotational movement around the horizontal axis.

The amount of the movement of the camera-moving mechanism 232 is controlled by a movement-control section 233 connected with the control unit 230.

It should be noted that the sufficient movable range of the camera-moving mechanism 232 should be set in consideration of variations in heights and postures of a plurality of inspectors 208.

The inspector's-image-capturing camera 221 and the unit 231 for detecting information associated with the line of sight constituting the section for detecting the information associated with the line of sight of the visual inspection apparatus 200 detect the view point position of the inspector 208 by conducting an image-processing of a captured image of the face 208a of the inspector 208.

An example of the inspector's-image-capturing camera 221 for capturing an image of the face 208a of the inspector 208 may include a CCD camera or the like. In addition, the captured data can be transmitted to the unit 231 for detecting information associated with the line of sight.

The inspector's-image-capturing camera 221 may be disposed at an arbitrary position which is can capture an image of the face 208a of the inspector 208 and detect the view point position relative to the substrate 1 disposed at the macro-inspection position P2. In the present embodiment, the inspector's-image-capturing camera 221 is disposed on an optical path divided by a half mirror 220 provided between the substrate 1 supported by the macro-inspection-tilting mechanism 209 and the inspector 208 as shown in FIG. 11.

As shown in FIG. 12, the unit 231 for detecting information associated with the line of sight includes an image-processing section 222, an initial-information-storage section 223, an image comparator section 224, and a position-calculating section 225.

The image-processing section 222 conducts image-processing operation including controlling of the image-capturing movement of the inspector's-image-capturing camera 221 and transferring of the image data of the inspector 208 obtained by the inspector's-image-capturing camera 221 so that comparisons can be made associated with the position of the eyes and the size of the eyes in a frame of image.

For example, the image-processing section 222 conducts edge extraction for the image of the face 208a and converts into a line image as shown in FIG. 13.

Features including the right eye 208d, the left eye 208e, and the contour 208f of the face are extracted based on the line images as such, and feature quantities associated with right eye's width d₁, left eye's width d₂, right eye's center coordinate G1, left eye's center coordinate G2, viewpoint's center position Q, distance d₃ between the right and left eyes, and the like can be calculated based on the shape of these extracted features. Coordinate values used herein indicate coordinates of pixels measured with respect to an origin O in an image frame 226.

The inspector's-image-capturing camera 221 captures an image of the face 208a which will be a reference image for calculating an view point position. Subsequently, the image-processing section 222 conducts image processing to the captured image. After that, the initial-information-storage section 223 stores image data obtained by the image processing.

The reference image is obtained by capturing an image of the face 208a of the inspector 208 by the inspector's-image-capturing camera 221 while the face 208a is positioned at a predetermined reference-image-capturing position.

The image comparator section 224 obtains information associated with the line of sight with reference to the line of sight of the inspector 208 at the reference-image-acquisition position by comparing the image data of the face 208a of the inspector 208 captured after the inspection and having undergone the image-processing conducted by the image-processing section 222 with the image data stored in the initial-information-storage section 223, and by obtaining information associated with variation in the position and size of the eye.

That is, the image comparator section 224 calculates the aforementioned feature quantity by checking for correlation between the image data stored in the initial-information-storage section 223 and the new obtained image data, and by specifying the positions of the right eye 208d and the left eye 208e if they moved.

The position-calculating section 225 converts the information associated with the line of sight of the inspector 208 calculated by the image comparator section 224 into space coordinates based on the position of the inspector's-image-capturing camera 221 and the position where an image of the reference image stored in the initial-information-storage section 223 is captured, and converts the space coordinates into information associated with the line of sight of the inspector 208 relative to the central position of the tilting movement of the substrate 1 in the visual inspection apparatus 200.

The control unit 230 which is a measure to conduct comprehensive control associated with macro-inspection is formed by, for example, an external storage section or the like including a CPU, a memory, an input-output interface, and a harddisk drive, etc. If necessary, the memory and external storage section store data, for example, information associated with the tilting position or the like which will be explained later. Therefore, the control unit 230 also serves as the tilt-position-storage section.

In addition, the control unit 230 connected electrically with the camera 211, the movement-control section 233, the macro-inspection-tilting mechanism 209, the unit 231 for detecting information associated with the line of sight, and the operation section 217 respectively is configured to be able to pass or receive control signals and data relative to each component. Therefore, the control unit 230 serves as the image-capturing-movement-control section for controlling the image-capturing movement of the camera 211.

In the present embodiment, a plurality of image-capturing movement modes are set for the camera 211. For example, the selectable modes include: temporary-image-capturing mode for capturing an image showing a defect every time a defect is detected during inspection; and all-time-image-capturing mode in which information associated with the tilting position corresponding to a detected defect and information associated with the line of sight of the inspector 208 when the defect is detected are stored during inspection, and in which an image of the defect corresponding to the stored tilting position is captured based on instructions input into the operation section 217.

The micro-inspection section 213 includes: a microscope 214 having an observation point in the vicinity of the micro-inspection-passing position P3; and an XY-stage 215 for transferring and moving the substrate 1 between the micro-inspection-passing position P3 and the observation point of the microscope 214 and for moving the substrate 1 relative to the observation point of the microscope 214.

The microscope 214 is configured to obtain image data of an image observed during micro-inspection and to allow the inspector 208 existing in the vicinity of the operation section 217 to conduct observation through a eyepiece lens 216.

The operation section 217, provided for allowing the inspector 208 using the visual inspection apparatus 200 to conduct macro-inspection and micro-inspection to the substrate 1, has various operation-input section including a keyboard, various buttons, and switches or the like. These operation-input sections include components for controlling, for example, starting, ending, and suspending of inspection, restarting of inspection for a new inspection object, various setting, and manual operation for each mechanism.

The operation-input section provided associated with macro-inspection has at least a joystick 217a for controlling the tilting movement of the macro-inspection-tilting mechanism 209; and a tilt-position-storage button 217b (operation section for storing the tilting position), that are connected to the control unit 230 respectively.

The tilt-position-storage button 217b stores the information associated with the tilting position of the macro-inspection-tilting mechanism 209 when the tilt-position-storage button 217b is pressed down by the inspector 208; and provides an instruction for obtaining the information associated with the line of sight of the inspector 208 at that time.

The monitor 218 displays operation menu, an image captured by the microscope 214, an image captured by the camera 211, etc. based on instructions provided by the control unit 230 if necessary.

A standing position or a sitting position for the inspector 208 who conducts macro-inspection and micro-inspection is provided in the vicinity of the operation section 217.

The macro-inspection is visual observation that inspects the substrate 1 supported by the macro-inspection-tilting mechanism 209 through an observation window 219 from the inspection position.

The observation window 219 may be a simple transparent window if it readily enables recognition of a defect in visual observation. Alternatively, a graphic object, for example, crossed lines or a circle mark, serving as an index for the position through which a normal line of sight passes may be provided for stabilizing the position of a line 208a of vision of the inspector 208 and the posture of the inspector 208.

The micro-inspection is conducted by viewing through the eyepiece lens 216 from the inspection position or by viewing the image displayed on the monitor 218.

The movement of the visual inspection apparatus 200 in the present embodiment will be explained next particularly with reference to the movement in the macro-inspection.

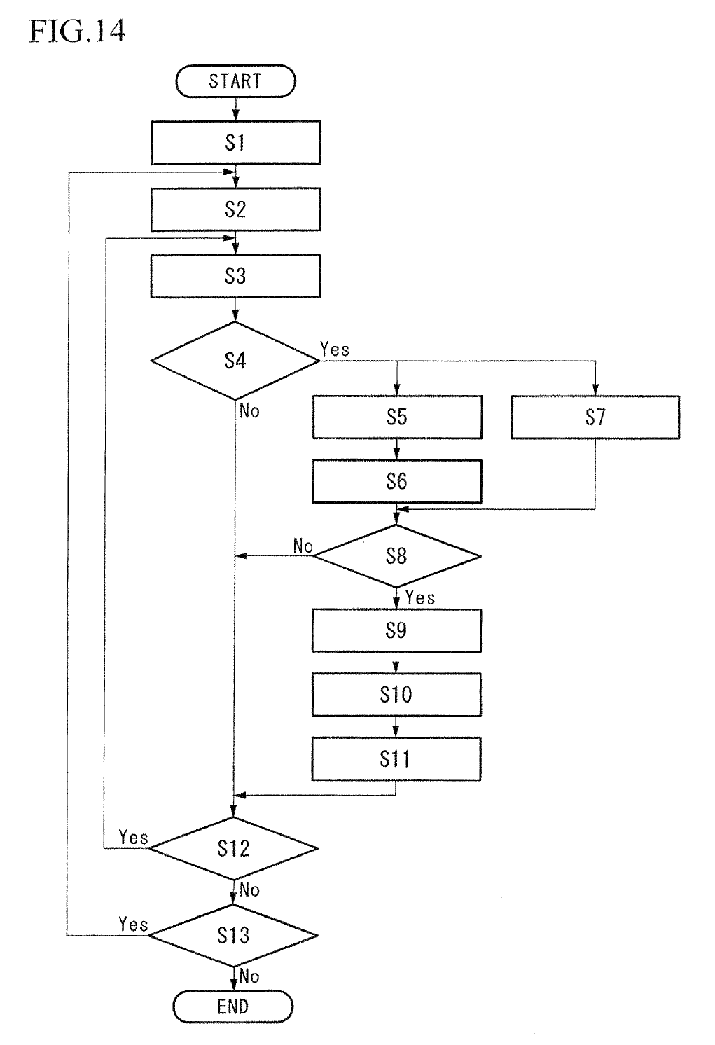

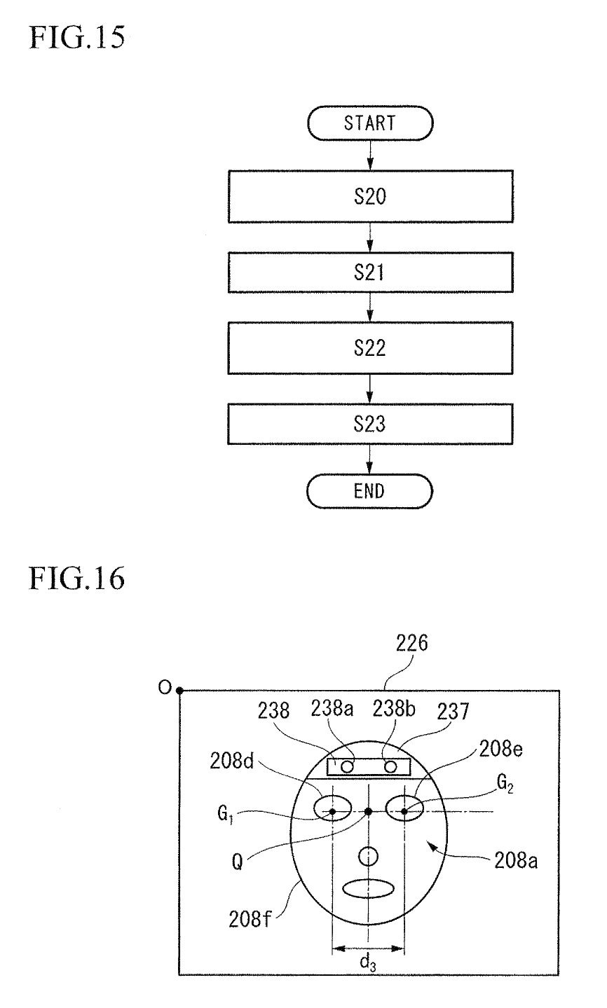

FIG. 14 is a flowchart for explaining operations of a macro-inspection conducted by the visual inspection apparatus according to the fourth embodiment of the present invention. FIG. 15 is a flowchart for explaining operations of a step for detecting the information associated with the line of sight conducted by the visual inspection apparatus according to the fourth embodiment of the present invention.

The macro-inspection is conducted in accordance with a flowchart as shown in FIG. 14.

Step S1 conducts initial setting for the macro-inspection. Initial-setting items are provided for setting various items if necessary. For example, items to be set for the macro-inspection include setting or adjusting, etc. of lighting condition of the illuminating section 234. In addition, image-capturing mode is selected for a case of detecting a defect, and flags are set in the control unit 230.

In addition, the reference image for the inspector 208 may be obtained in the step S1. That is, the image of the face 208a of the inspector 208 disposed at the reference-image-capturing position is captured by the inspector's-image-capturing camera 221; the captured image undergoes a predetermined image-processing conducted by the image-processing section 222; and the processed image is stored in the initial-information-storage section 223.

However, the reference image as such may be obtained at the time of starting up the visual inspection apparatus 200, and alternatively, the reference image as such may be obtained temporarily if necessary. For example, the reference image as such may be obtained by suspending the inspection step temporarily when a next job shift of inspector 208 takes over the inspection. An image-capturing operation for a reference image can be omitted if the reference image of a potential inspector 208 is stored previously.

The substrate 1 is transferred to the macro-inspection position P2 in step S2.

That is, an uninspected substrate 1 contained in the enclosure 205 is transferred and passed to the substrate-passing position P1 by the substrate-transfer robot 204, and then, supported by, for example, the transfer arm 207a by means of suctioning. Subsequently, the transfer arm 207a is moved to the macro-inspection position P2 by rotating the rotative transfer mechanism 206 by 120 degrees. Since a transfer arm 207c, which has been disposed at the micro-inspection-passing position P3, moves to the substrate-passing position P1 at this moment, a substrate 1 which will be inspected next is set to the transfer arm 207c by the substrate-transfer robot 204.

In step S3, visual inspection is conducted to the substrate 1 supported by the macro-inspection-tilting mechanism 209 while tilting the substrate 1.

That is, the suctioned state of the substrate 1 provided by the transfer arm 207a is released when the substrate 1 is transferred to the macro-inspection position P2. Subsequently, the substrate 1 is moved onto the macro-inspection-tilting mechanism 209 which is movable in the vertical direction relative to the transfer arm 207a and supported by the macro-inspection-tilting mechanism 209 by suction method.

The inspector 208 conducts visual inspection to the substrate 1 disposed at various tilting positions and illuminated by the illuminating section 234 while tilting the substrate 1.

The tilting movement of the substrate 1 is automatic based on information, indicative of starting of inspection, provided into the operation section 217 if the information associated with the tilting position and the tilting pattern are stored in the control unit 230 previously. If necessary, the inspector 208 can stop the tilting movement to switch to manual operation using the tilt-position-storage button 217b, and then tilt the substrate 1 to an angle that facilitates visual observation of a defect. If the information associated with the tilting position and the tilting pattern is not stored in the control unit 230 previously, the inspector 208 conducts visual inspection to the substrate 1 while tilting the substrate 1 by manual operation from the start of the inspection.

The inspector 208 upon finding a defect during the inspection in this state presses down the tilt-position-storage button 217b immediately for storing the current tilting position of the macro-inspection-tilting mechanism 209.

Subsequently, an interrupt occurs in the control unit 230, and step S4 determines whether or not the tilt-position-storage button 217b has been pressed.

If it is determined that the tilt-position-storage button 217b has been pressed, the control unit 230 executes steps S5 and S7 immediately.

If it is determined that the tilt-position-storage button 217b has not been pressed, the flowchart transfers to step S12.

The step S5 conducts detecting of the information associated with the line of sight which is started based on a control signal provided to the unit 231 for detecting information associated with the line of sight from the control unit 230.

The step for detecting the information associated with the line of sight in the present embodiment is executed in accordance with the flowchart as shown in FIG. 15.

The image of the inspector 208 in the image frame 226 is captured by the inspector's-image-capturing camera 221 in step S20. Since the control signal is transmitted by the control unit 230 to the unit 231 for detecting information associated with the line of sight immediately after the tilt-position-storage button 217b is pressed, the image of the face 208a of the face 208a (hereinafter called simply a face image) which will be captured in this state substantially represents the inspector 208 at the time of pressing of the tilt-position-storage button 217b.

In step S21, image-processing is conducted to the face image in this state by the image-processing section 222, and the face image is converted into, for example, a line image as shown in FIG. 13, and transfers the converted line image to the image comparator section 224.

In step S22, the face image having undergone the image-processing is compared with the reference image stored in the initial-information-storage section 223 by the image comparator section 224 to obtain information associated with variation in the position and size of the eye.

Subsequently, the right eye 208d, the left eye 208e, and the contour 208f of the face, etc. are extracted based n these images, and then, the feature quantity including the right eye's width, left eye's width, right eye's center coordinate, left eye's center coordinate, viewpoint's center position, distance between the right and left eves, and the like is calculated on the display based on these shapes. In the following, each quantity for the case of reference image is represented by d₁, d₂, G₁, G₂, Q, and d₃, and each quantity for the case of face image is represented by (d₁+Δd₁), (d₂+Δd₂), (G₁+ΔG₁), (G₂+ΔG₂), (Q+ΔQ), and (d₃+Δd₃). G₁, G₂, and Q listed herein indicate vector quantities.

Subsequently, variations in the position of the center of the view point and the direction of the line of sight relative to the image-capturing position of the reference image can be obtained by comparing proportion among the right eye's width represented by γ₁=(d₁+Δd₁)/d₁, the left eye's width represented by γ₂=(d₂+Δd₂)/d₂, and the distance between the right and left eyes represented by γ₃=(d₃Δd₃)/d₃; and by converting the obtained variations into distances in an actual three-dimensional space based on the feature in angle of view in the image-capturing optical system of the inspector's-image-capturing camera 221.

The present embodiment utilizes a fact that a usual inspector 208 takes a posture not causing undue stress in order to reduce uneven results in inspection and seizes the object in the center of the field of view that can provides a stable view of defect. That is, as a precondition, the inspector 208 upon detecting a defect directs the face 208a thereof to be opposed to the visible side of the defect for obtaining appropriate view of the defect, and the inspector 208 brings the defect into the center of the field of view for finally recognizing the defect.

In a case of satisfying a relationship of γ1=γ2=γ3=γ, this indicates that the face 208a has made a parallel movement from the time of capturing of the reference image.

In a case of γ=1, this indicates a parallel movement in a plane having the face 208a disposed therein. In a case of γ>1, this indicates the inspector 208 in closer state to the inspector's-image-capturing camera 221. A relationship γ<1 reveals a farther separated state of the face 208a.

If there is a difference among the sizes of γ₁, γ₂, and γ₃, this indicates that the face 208a has rotated in the horizontal plane.

For example, if a relationship γ₁>γ₂>γ₃ is effective, this reveals that the face 208a has rotated in a direction in which the right eye approaches to the inspector's-image-capturing camera 221 and the left eye moves away from the inspector's-image-capturing camera 221.

If the inspector 208 moves in the optical axis direction of the inspector's-image-capturing camera 221 and the face 208a is rotated, the degree of the movement of the inspector 208 and the degree of rotation of the face 208a can be separated by calculating the amount of offset that is common in the movement in the optical axis direction based on the significance of the ratio among γ₁, γ₂, and γ₃.

Accordingly, the position of the center of the view point and the direction of the line of sight of the inspector 208 relative to the reference-image-capturing position can be calculated based on the information associated with two-dimensional reference image and the two-dimensional flag setting.

The information associated with the line of sight including the position of the center of the view point and the direction of the line of sight is transferred to the position-calculating section 225.

In calculation conducted in step S23, the position-calculating section 225 converts the information associated with the line of sight of the inspector 208 calculated by the image comparator section 224 into space coordinates based on the position of the inspector's-image-capturing camera 221 and the position where an image of the reference image stored previously in the initial-information-storage section 223 is captured, and converts the space coordinates into information associated with the line of sight of the inspector 208 relative to the central position of the tilting movement of the substrate 1 in the visual inspection apparatus 200.

This concludes the step for detecting the information associated with the line of sight.

In next step S6 (see FIG. 14), the information associated with the line of sight of the inspector 208 and calculated in the step S5 is transferred to the control unit 230 and stored therein.

On the other hand, a next step S7 is executed concurrently with the steps S5 and S6.

In step S7, information associated with the tilting position indicative of the state of the tilting position of the macro-inspection-tilting mechanism 209 when the tilt-position-storage button 217b is pressed is stored in the control unit 230. The information associated with the tilting position includes, for example, the coordinate corresponding to the position of the center of the tilting movement; and the information corresponding to the direction of the normal provided onto the substrate 1 supported by the macro-inspection-tilting mechanism 209, etc.

A step S8 is executed after concluding the aforementioned steps S6 and S7.

Step S8 determines whether or not an image showing a defect at the time of pressing the tilt-position-storage button 217b will be captured. That is, the flowchart transfers to step S9 if a flag that has been previously set associated with image-capturing mode indicates the temporary-image-capturing mode.

Alternatively, the flowchart transfers to step S12 if the flag indicates the all-time-image-capturing mode.

In step S9, correlation between the position of the substrate 1 and the position of the inspector 208 is calculated based on the information associated with the line of sight and the information associated with the tilting position stored in the control unit 230, and then, the tilting position of the macro-inspection-tilting mechanism 209, and the position and attitude of the camera 211 are calculated so that the view point position and direction of the line of sight of the inspector 208 will be converted to the image-capturing position and the optical axis for image-capturing of the camera 211 that are substantially and optically equal to the view point position and the direction of the line of sight of the inspector 208.

In next step S10, the macro-inspection-tilting mechanism 209 is moved to the tilting position calculated in the step S9, and the camera 211 is moved to the similarly calculated image-capturing position.

For example, FIG. 11 shows a case in which the line 208b of vision detected based on the information associated with the line of sight coincides with a usual direction of the line of sight when N₁ indicates a normal vector of the substrate 1 calculated based on the information associated with tilting movement. In this configuration, the image-capturing position of the camera 211 may be set by rotating the macro-inspection-tilting mechanism 209 around the vertical axis by angle θ so that the view point position of the inspector 208 is rotated by the angle θ. That is, the image-capturing optical axis 211a of the camera 211 may be brought into the same state as that of the line 208a of vision that is rotated relative to the center of the substrate 1 by the angle θ.

In another case in which line 208c of vision detected based on the information associated with the line of sight indicates the line of sight that is deviated from the usual line of sight of the inspector 208A (as shown in FIG. 11), the image-capturing position of the camera 211 may be brought into the same state as the view point position of the inspector 208A by adjusting the position and attitude of the camera 211 by means of the camera-moving mechanism 232.

Such adjustment of positions is not limited to the rotational movement of the macro-inspection-tilting mechanism 209 around the vertical axis. Tilting movement having appropriate direction and angle may be provided to the macro-inspection-tilting mechanism 209 alone if the position of the camera 211 relative to the substrate 1 can be brought into the same relationship of position that is converted based on the information associated with the line of sight and the information associated with the tilting position. In addition, the moving of the camera 211 may occur concurrently with the tilting of the macro-inspection-tilting mechanism 209. Cooperative movement of the macro-inspection-tilting mechanism 209 like this is advantageous because the movable range of the camera 211 can be minimized.

In step S11, an image of the substrate 1 is captured by the camera 211, and if necessary, the captured image is displayed on the monitor 218, or the image data are stored in a harddisk drive unit or the like. Subsequently, the flowchart transfers to step S12.

Step S12 determines whether or not the inspection will be continued based on whether an instruction indicative of ending of the inspection has been input.

The flowchart transfers to step S13 upon determining discontinuation of inspection if an instruction indicative of ending of inspection has been put in.

The flowchart repeats the aforementioned operations that start from the step S3 in all other cases.

The step S13 determines whether or not the inspection will be continued by switching the inspection object to an uninspected next substrate 1 by checking for an instruction.

In a case of detecting an instruction indicative of switching of the substrate 1 and continuing of the inspection, the suctioned state of the substrate 1 provided by the macro-inspection-tilting mechanism 209 is released, and the macro-inspection-tilting mechanism 209 is retracted to a position which does not interfere with the movement of the rotative transfer mechanism 206, and then the substrate 1 is suctioned by the transfer arm 207b. In addition, the flowchart repeats the aforementioned operations that start from the step S2.

The flowchart concludes all operations in the macro-inspection if an instruction indicative of switching of the substrate 1 and continuing of the inspection has not been detected.

In the case of all-time-image-capturing mode that has been set previously, if an instruction indicative of capturing of an image showing a defect is provided, the control unit 230 handles an interrupt service to execute operations that are similar to those conducted in the steps S9, S10, and S11.

As explained above, in the visual inspection apparatus 200 according to the present embodiment, the information associated with the line of sight of the inspector 208 is obtained by the unit 231 for detecting information associated with the line of sight; and the information associated with the tilting position of the macro-inspection-tilting mechanism 209 is obtained by the control unit 230 by pressing the tilt-position-storage button 217b. Accordingly, a visible captured image of the substrate 1 having the same state as that of the image visually observed by the inspector 208 can be displayed on the monitor 218 or stored as image data since the image of the substrate 1 can be captured based on the information associated with the line of sight and the information associated with the tilting position so that the optical axis 211a for image-capturing of the camera 211 is disposed at a position that is optically equivalent to the line of sight of the inspector 208.

Therefore, defect-associated information can be easily reviewed or shared by inspectors because the visible image of defect detected by the inspector 208 can be transmitted to other inspectors 208 or can be stored for record.

Since the camera 211 can be disposed at a position different from the inspection position of the inspector 208 by moving the camera 211 based on the position of the macro-inspection-tilting mechanism 209, an image can be captured at a position which does not interfere with the inspection conducted by the inspector 208. Therefore, inspection and image-capturing can be conducted effectively.

In another case in which the substrate 1 is disposed a fixed tilting position, a defect detected at a position which is deviated from a usual eye view position can be detected as information associated with the line of sight if the inspector 208 conducts inspection by moving his view point to facilitate the observation for the defect. Therefore, the defect in this case having the same state as that of the visual observation can be obtained easily as a visible image; thus, accuracy and efficiency in the inspection can be enhanced.

A first modified example associated with the fourth embodiment will be explained next.

In the present modified example as shown in FIG. 11 with two-dot chain lines, the visual inspection apparatus 200 according to the aforementioned embodiments is added to an illuminating-section-moving mechanism 235 and an illumination-position-control section 236 for movably supporting the illuminating section 234. Different points from the aforementioned embodiments will be explained as follows.

The illuminating-section-moving mechanism 235 includes a stage or the like movable in a predetermined direction for movably supporting at least one of the illumination positions and the illumination direction of the illuminating section 234 with respect to the substrate 1. The present modified example is configured to maintain the predetermined illumination position and illumination direction during visual inspection, and to change at least one of the illumination position and the illumination direction with respect to the substrate 1 at the time of the visual inspection in accordance with the movement of the macro-inspection-tilting mechanism 209 and the camera 211 if it is necessary to capture an image of a defect.

The illumination-position-control section 236 is provided for controlling degree of the movement and the direction of the movement of the illuminating-section-moving mechanism 235 based on a control signal provided by the control unit 230.

Operations conducted in the present modified example are substantially the same as those in the flowchart as shown in FIG. 14. The step S9 determines whether or not the illumination light illuminated onto the substrate 1 must be moved in accordance with the position of the moved camera 211 and the tilting position of the macro-inspection-tilting mechanism 209. If it must be moved, the position to which the illuminating section 234 must be moved is calculated. If it must be moved, the illuminating section 234 together with the camera 211 and the macro-inspection-tilting mechanism 209 is moved in the step S10.

The illuminating section 234 must be moved in some cases including: a case in which a captured image of defect may differ from a visually observed image because various conditions of the light illuminated to the substrate 1 including, for example, the illumination position, illumination direction, and illumination range vary over tolerable limits when the camera 211 and the macro-inspection-tilting mechanism 209 move; and a case in which the illumination condition at the time of image-capturing must be optimized to a different condition from that of the visual observation because the optical features of the camera 211 including, for example, exposure sensitivity, angle of view, and depth of field differ from ocular properties of the inspector 208. In any case, the condition for moving the illuminating section 234 is preset based on beforehand experiments.

As previously explained, the present modified example is advantageous because the illumination position and the illumination direction can be changed in accordance with the positions of the moved camera 211 and the macro-inspection-tilting mechanism 209 to coincide the illuminating condition during image-capturing with the illuminating condition during visual inspection, and because the illuminating condition during image-capturing can be optimized in accordance with the feature of the camera 211 to capture the image of a defect that is closer to the image obtained during visual inspection.

A second modified example associated with the fourth embodiment will be explained next.

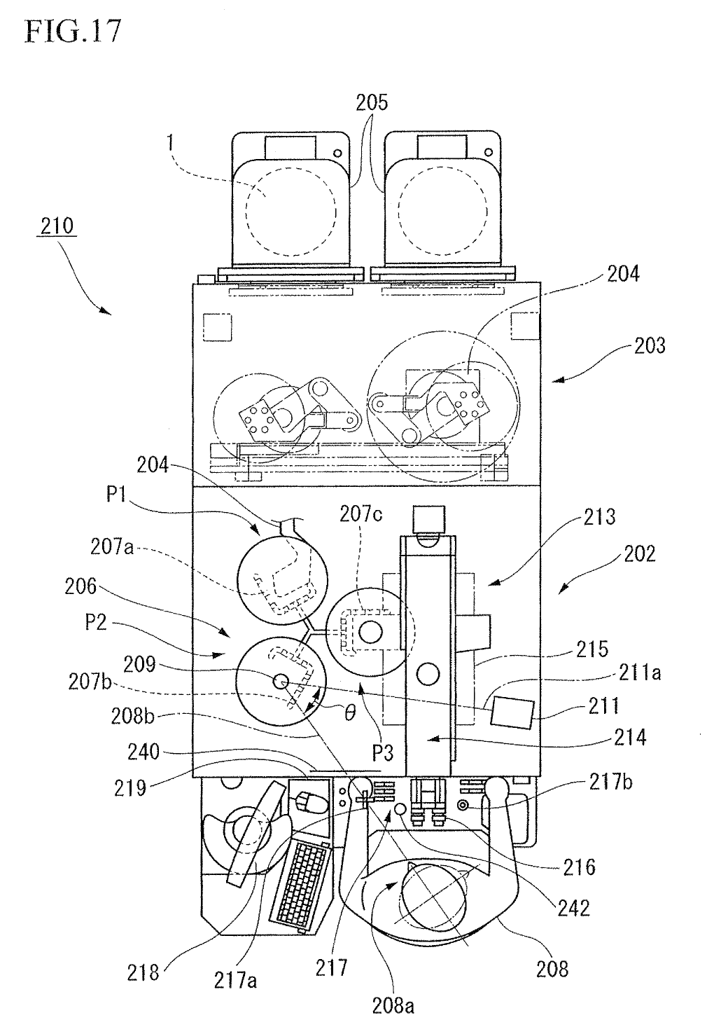

FIG. 16 is a schematic view showing an example of a reference image showing targets used in a second modified example of the fourth embodiment of the present invention.

In the present modified example, information associated with the line of sight is obtained based on characteristics other than the position and the size of the eye when image-processing is conducted to an image captured by the inspector's-image-capturing camera 221. For example, in this configuration, the inspector 208, in an attempt to obtain the information associated with the line of sight, has a target provided onto his face 208a or a part of the body in advance so that the image captured by the inspector's-image-capturing camera 221 is converted to the information associated with the line of sight by calculating the position and size of the target. In the case of the present modified example, the inspector's-image-capturing camera 221 is used as the target-image-capturing section, and the unit 231 for detecting information associated with the line of sight is used as the target-image-processing section.

For example, the target set to a section which links with the movement of the head part of the inspector 208 may be a detectable sticker or a plate having a specific color, shape, or size.

One of the examples as shown in FIG. 16 is a cap 237 having a plate 238 attached thereto for detection-use, which is provided with a right target 238a (target) and a left target 238b (target) each attached to the front end of the cap 237 and having an easily detectable round shape or the like so that the center part thereof can be easily recognized. Otherwise, the target can be attached to the face or the head part of the inspector 208 or to working glasses worn by the inspector 208.

A reference image of the present modified example is captured while the inspector 208 wears the cap 237. Subsequently, correlation of the positions among the central position of the right target 238a, the central position of the left target 238b, a right eye's center G1, a left eye's center G2, and the viewpoint's center position Q is calculated, and the reference image is stored in the initial-information-storage section 223.

Therefore, the configuration of the image-processing section 222 can be more simplified and efficiency in the image-processing can be enhanced since the image-processing section 222 can use the image of the right target 238a and the image of left target 238b that facilitate image recognition and obtain position-associated information easily in place of the images of the right eye 208d and the left eye 208e of the inspector 208.

### Fifth Embodiment

A visual inspection apparatus according to a fifth embodiment of the present invention will be explained.

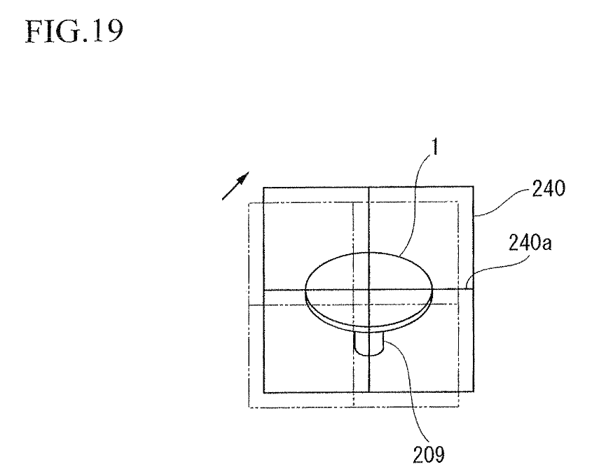

FIG. 17 is a plan view showing the configuration of a visual inspection apparatus according to a fifth embodiment of the present invention. FIG. 18 is a block diagram showing the configuration of an inspection section and an operation section in the visual inspection apparatus according to the fifth embodiment of the present invention. FIG. 19 is a schematic view showing the correlation between the inspection object and a movable index viewed by the inspector by means of the visual inspection apparatus according to the fifth embodiment of the present invention.

As shown in FIGS. 17 and 18, a visual inspection apparatus 210 according to the present embodiment is configured by deflecting the inspector's-image-capturing camera 221 and the half mirror 220 from the visual inspection apparatus 200 of the fourth embodiment, adding an index plate 240 (movable index), an index-moving mechanism 241, and an index-position-operating section 242 to the visual inspection apparatus 200, and replacing the unit 231 for detecting information associated with the line of sight with a unit 243 for detecting information associated with the line of sight (index-position-calculating section). Features different from the aforementioned fourth embodiment will be explained as follows.

The index plate 240 is a transparent plate member disposed at a position proximate to the observation window 219 between the observation window 219 and the substrate 1. As shown in FIG. 19, an index 240a provided to the index plate 240 has a graphic object that facilitates aligning of its central position with respect to the substrate 1 in the field of view of the inspector 208. For example, the shape of the graphic object may be a cross, a circle, or an oblique cross.

The index-moving mechanism 241 is configured to support the index plate 240 movably and move the index plate 240 in a direction across the line 208a of vision so that the index 240a of the index plate 240 can label the passing position of the line 208a of vision. The present embodiment is configured so that a grasping frame of the index plate 240 can be moved in two axial directions along the observation window 219 in accordance with the instruction provided via the index-position-operating section 242 operated by the inspector 208; the position of the grasping frame can be detected; and the movement-position information of the grasping frame can be transmitted to the unit 243 for detecting information associated with the line of sight.

The unit 243 for detecting information associated with the line of sight is provided for converting the movement-position information transmitted from the index-moving mechanism 241 into the information associated with the central position of the index 240a of the index plate 240; and for calculating the information associated with the line of sight in order to indicate that the line 208a of vision will be formed on a line segment which connects the central position of the index 240a and the central position of the tilting movement of the substrate 1.

The macro-inspection conducted by the inspector 208 using the visual inspection apparatus 210 according to the present embodiment is substantially the same as the flowchart shown in FIG. 14, but has the following different points.

In the step S1, operations using the inspector's-image-capturing camera 221 for obtaining the reference image are not conducted.

In the step S3, the inspector 208 upon detecting a defect operates the index-position-operating section 242 and moves the index plate 240 to coincide the central position of the index 240a with the center of the substrate 1 at the time of finding the defect. After that, the tilt-position-storage button 217b is pressed.

Here in order to prevent an inadvertent operation of pressing the tilt-position-storage button 217b without moving the index plate 240 from making inaccurate record of information associated with the line of sight, it is preferable to provide a step of preventing an erroneous record including operations, for example, for determining whether or not the index-position-operating section 242 has been operated within a predetermined length of preceding time when the tilt-position-storage button 217b is pressed; for invalidating the operational input provided by the tilt-position-storage button 217b if the determination indicates that the index-position-operating section 242 has been operated; and for displaying a message on the monitor 218 to indicate that the index plate 240 is not moved.

In addition, in the step S5, when the tilt-position-storage button 217b is pressed, the information associated with the line of sight is calculated based on the movement-position information of the index-moving mechanism 241 by the unit 243 for detecting information associated with the line of sight. That is, the movement-position information stored in the index-moving mechanism 241 is converted to the coordinate of the central position of the index 240a and further converted to a coordinate system in which the origin is the central position of the tilting movement of the macro-inspection-tilting mechanism 209; and the directional vector or the like of the line 208a of vision is obtained.

Since this case is different from the fourth embodiment, the absolute position of the view point is unknown because the distance to the inspector 208 cannot be calculated. Therefore, only the direction of the line of sight is stored in the step S6.

In addition, a image-capturing position is calculated in the step S9 so that: the correlation between the optical axis 211a for image-capturing and the substrate 1 coincides with the correlation between the line 208a of vision and the substrate 1 that are included in the information associated with the line of sight; a full image of the substrate 1 is obtained by disposing the center of the tilting movement of the substrate 1 in the center of the image; and a focusing position can be identical with the center of the substrate 1.

As previously explained, in the present embodiment, the section for detecting the information associated with the line of sight includes the index-moving mechanism 241 and the unit 243 for detecting information associated with the line of sight for detecting the information associated with the line of sight without using the image-processing section. Also, the present embodiment calculates the image-capturing position of the image-capturing section without calculating the absolute position of the view point.

Therefore, the present embodiment capable of capturing a visible image of the substrate 1 having the identical state with the image visually observed by the inspector 208 similarly to the fourth embodiment can display the visible image on the monitor 218 or store the image data. In addition, the information associated with the line of sight can be detected easily since the information associated with the line of sight is obtained by moving the index plate 240 in accordance with the line of sight of the inspector 208.

### Sixth Embodiment

A visual inspection apparatus according to a sixth embodiment of the present invention will be explained.

FIG. 20 is a block diagram showing the configuration of an inspection section and an operation section in the visual inspection apparatus according to the sixth embodiment of the present invention.

As shown in FIG. 20, a visual inspection apparatus 250 according to the present embodiment is configured by deleting the inspector's-image-capturing camera 221 and the half mirror 220 from the visual inspection apparatus 200 of the fourth embodiment, adding a position-detection sensor 239, and replacing the unit 231 for detecting information associated with the line of sight with unit 244 for detecting information associated with the line of sight (positional-information-calculating section). Features different from the aforementioned fourth embodiment will be explained as follows.

The position-detection sensor 239, which detects the position and the direction with respect to gravitational acceleration, is fixed in the vicinity of the eye of the inspector 208 during inspection, for example, a temple section of the head. Therefore, the position-detection sensor 239 having a constant positional relationship with the eye with an appropriately controlled positioning accuracy can calculate an approximate value concerning a position of the center of the view point based on the position-associated information obtained by the position-detection sensor 239.

One of adoptable examples for fixing the position-detection sensor 239 to the head part may be a detachable attachment like a hair band, a frame, or a cap having the position-detection sensor 239 detachably attached onto the inspector 208.

The output detected by the position-detection sensor 239 is configured to be transmitted to the unit 244 for detecting information associated with the line of sight.

The position-detection sensor 239 performs an appropriate calibration for the position every time it is attached to the inspector 208. For example, the inspector 208 having the position-detection sensor 239 attached to him stands at the reference position and conducts visual observation while a calibration reference is disposed at a predetermined position, and then, currently-obtained position-associated information is stored as calibration data in the unit 244 for detecting information associated with the line of sight.

The unit 244 for detecting information associated with the line of sight is a component for obtaining a position-associated information based on the position-detection sensor 239 when the tilt-position-storage button 217b is pressed; comparing the obtained position-associated information with the calibration data; and calculating the information associated with the line of sight based on a degree of shift of line of sight of the inspector 208 who observes the calibration reference.

The macro-inspection conducted by the inspector 208 using the visual inspection apparatus 250 according to the present embodiment is substantially the same as the flowchart shown in FIG. 14, but has the following different points.

In the step S1, operations using the inspector's-image-capturing camera 221 for obtaining the reference image are not conducted.

In addition, in the step S5, when the tilt-position-storage button 217b is pressed, the information associated with the line of sight is calculated by the unit 244 for detecting information associated with the line of sight based on the position-associated information obtained by position-detection sensor 239. The information associated with the line of sight includes an approximate value of the coordinate of the position of the center of the view point and the information associated with the direction of the line of sight.

As previously explained, in the present embodiment, the section for detecting the information associated with the line of sight includes the position-detection sensor 239 and the unit 244 for detecting information associated with the line of sight for detecting the information associated with the line of sight without using the image-processing section.

Therefore, the present embodiment capable of capturing a visible image of the substrate 1 having the identical state with the image visually observed by the inspector 208 similarly to the fourth embodiment can display the visible image on the monitor 218 or store the image data. In addition, the information associated with the line of sight can be detected more easily since the information associated with the line of sight is obtained by the position-detection sensor 239.

In addition, all the aforementioned embodiments may be configured to conduct remote control to the visual inspection apparatus so that a controller computer provided with a monitor disposed in the exterior of a clean room for displaying an image associated with inspection is connected to the visual inspection apparatus via a communication line; the controller computer transmits the operation information obtained based on the result of the operation conducted by the operator to the visual inspection apparatus; and the visual inspection apparatus upon receiving the operation information is operated based on the operation information. That is, an image which is obtained at every inspection point and is substantially identical with the visually observed image can be obtained at another location via the communication line if an ordinary inspector uses the visual inspection apparatus according to the present invention for conducting inspection based on operational information (recipe) that is same as that used in visual inspection using an inspection apparatus; therefore, each inspector does not have to be in front of each inspection apparatus, and inspection under remote control can be conducted at a separate location from the inspection apparatus.

The controller computer may be connected to the visual inspection apparatus by means of wire network, wireless network, or serial communication using private lines. The controller computer may have configuration that is equivalent to that of a general-purpose computer. That is, the controller computer is configured to include components such as: a control section including a CPU and chipsets or the like; an operation section including a mouse, keyboard, switches and the like; a storage section including a hard disk drive and RAMs for storing information; a display section including a monitor or the like for displaying the information; and an interface section supporting TCP/IP protocol or the like.

Conventionally used “Recipe information” defines how to inspect an inspection object substrate, more specifically, makes determination as to whether or not inspection will be conducted and as to what kind of condition is used for the inspection. The visual inspection apparatus may be controlled by the controller computer using the recipe information of this kind. This enables a sequential processing of inspection collectively and automatically that include transferring of the substrate, and conducting of macro-inspection and micro-inspection.

In a case of operating the visual inspection apparatus by an externally-located controller computer, image data produced by an image-capturing section is transmitted from a control section of the visual inspection apparatus to a controller computer. The controller computer upon receiving the image data displays an image produced based on the image data on a monitor. An inspector conducts visual inspection for a substrate while watching the images similarly to a case of conducting inspection in front of the visual inspection apparatus by tilting or moving the substrate via the operation section of the controller computer and checking for a defect and determining its type.

Since usually a clean room has the visual inspection apparatus therein, visual inspection for the substrate conducted while the inspector does not enter the clean room can enhance working efficiency. In addition, in a case of using a plurality of visual inspection apparatuses, one-man-operation can be conducted for the plurality of visual inspection apparatuses if the visual inspection apparatuses are connected to a controller computer located in the exterior of the clean room through a communication line so that each visual inspection apparatus can be controlled by the controller computer. Accordingly, the number of inspectors necessary for inspection work can be reduced while enhancing efficiency for using the apparatus; therefore, investment cost can be reduced.

As previously explained in each embodiment, the image-capturing section in this case captures an image that is identical with a visually observed image. That is, the image displayed on the monitor of the controller computer is identical with the visually observed image of a substrate obtained in visual inspection conducted by the inspector in front of the visual inspection apparatus. Therefore, strange feeling based on difference of view point will not occur since visual inspection can be conducted to the substrate based on conventionally accustomed images.

In a case of conducting visual inspection for the substrate in front of the visual inspection apparatus under visual observation, image data indicating inspection results and stored in the storage section of the control section may be transmitted to the controller computer disposed in the exterior of the clean room. In this case, for example, if the inspector provides an instruction of transmitting image data, the control section retrieves the image data from the internally-disposed storage section and transmits it to the controller computer. The controller computer receives the image data and stores it in the internally-disposed storage section. The image data is retrieved from the storage section and processed appropriately based on the instruction provided by the operator who operates the controller computer, and the monitor displays the image produced based on the processed image data. Accordingly, working efficiency can be enhanced since the results of visual inspection can be reviewed in the exterior of the clean room, and it is not necessary that the inspector to re-enter the clean room.

It should be noted that a distance measurement section may be provided on the inspector's-image-capturing camera 221 to obtain distance-associated information of the face 208a in place of the aforementioned fourth embodiment explained with reference to the example in which the distance between the face image captured by the inspector's-image-capturing camera 221 and the substrate is calculated based on the face image captured by the inspector's-image-capturing camera 221 for obtaining the position-associated information of the inspector 208. In this case, image-processing for the face image can be simplified.

The distance measurement section can adopt triangulation conducted by projecting measurement light toward the inspector 208 or stereo measurement conducted by using the inspector's-image-capturing camera 221 that acts as a stereo measurement camera.

In place of the fourth embodiment has been previously explained with reference to the example in which the feature in the outline of the eye is extracted for obtaining the information associated with the line of sight, other shape may be extracted as long as the position of the eye can be specified and the size of the eye can be measured. For example, a white part and pupil may be detected. In this case, accurate information associated with the line of sight can be obtained by detecting the position of the pupil for observing a defect under visual observation while the inspector 208 deflects his line of sight diagonally with respect to the front of the face 208a.

The position of the camera 211 is not limited to the position that has been explained in the aforementioned fourth to sixth embodiments and with reference to the example in which the camera 211 is disposed at substantially the same height as that of the head part of the inspector 208. For example, a more compact apparatus can be realized by changing the optical path appropriately by disposing a mirror or the like between the substrate 1 and the inspector 208.

In contrast to the previously explained example in which micro-inspection and macro-inspection are conducted to an inspection object substrate, the visual inspection apparatus may conduct macro-inspection alone. Also, the inspection object may not be limited to a semiconductor wafer.

For example, visual inspection may be conducted to a liquid crystal substrate. The present invention is advantageous because the image of a defect observed by shifting the view point of the inspector can be captured easily regardless of a commonly large-sized liquid crystal substrate which is sometimes difficult to be inspected while changing the tilting direction frequently.

The embodiments of the present invention have been explained above in details with reference to the drawings. However, it should be understood that the drawings and detailed description thereto are not intended to limit the invention to the particular form disclosed; thus, the invention disclosed herein is susceptible to various modifications and alternative forms, i.e., design changes.

Also, the components previously described in each embodiment can be combined appropriately within the scope of technical insight of the present invention as long as it is available technically. For example, the illuminating-section-moving mechanism 235 and the illumination-position-control section 236 of the first modified example of the fourth embodiment may be implemented in combination with the configuration in the fifth or the sixth embodiment.

What is claimed is:

1. A visual inspection apparatus, comprising:
an inspection-object-holder section for conducting visual inspection of an inspection object, the inspection-object-holder section supporting the inspection object and tilting the inspection object; and
an image-capturing section for capturing an image of the inspection object and producing image data, wherein
an optical axis of the image-capturing section is disposed to substantially coincide with a line of sight of an inspector who observes the inspection object during visual inspection.

2. A visual inspection apparatus according to claim 1, further comprising:
an image-capturing holder section for supporting the image-capturing section and moving the image-capturing section, wherein
movement of the image-capturing holder section is controlled so that: the image-capturing section is moved to a position that does not interfere with the visual observation conducted by the inspector who observes the inspection object; and the image-capturing section is moved to a position that is identical to an eye view position of the inspector who observes the inspection object.

3. A visual inspection apparatus according to claim 1, further comprising:
an illuminating section for illuminating the inspection object, wherein
three angles formed during the visual observation and defined by: an optical axis of the illuminating section directed toward a central position of the inspection object; a normal disposed on the inspection object; and a reference axis extending from the central position in an eye view direction of the inspector are identical respectively with
three angles formed during image-capturing conducted by the image-capturing section and defined by: the optical axis of the illuminating section directed toward the central position of the inspection object; the normal disposed on the inspection object; and an optical axis of an image-capturing optical system of the image-capturing section directed toward the central position of the inspection object, and
the illuminating section, the central position of the inspection object, and the eye view position that are disposed during the visual observation have identical correlation with those of the illuminating section, the central position of the inspection object, and the image-capturing section that are disposed during the image-capturing using the image-capturing section.

4. A visual inspection apparatus according to claim 1, wherein
the image-capturing section is disposed at a height that is identical to the height of the eye view position of the inspector so that an angle defined by the optical axis of the image-capturing section extending in image-capturing direction and by a horizontal plane is equal to an angle defined by an axis of eye view direction of the inspector and the horizontal plane,
the visual inspection apparatus further comprising a control section, wherein
the control section puts out a signal to the inspection-object-holder section during image-capturing of the inspection object for instructing rotation of the inspection object, and
the inspection-object-holder section rotates the inspection object around a rotational axis passing through the center of the inspection object and extending in the vertical direction based on the signal put out by the control section so that an image of the inspection object visually observed by the inspector is identical with an image of the inspection object captured by the image-capturing section.

5. A visual inspection apparatus according to claim 1, further comprising:
a control section;
a light-reflective plate; and
a reflective-plate holder section for supporting the light-reflective plate and moving the light-reflective plate, wherein
the control section controls movement of the reflective-plate holder section so that: the light-reflective plate is moved to a position that does not interfere with the visual observation conducted by the inspector who observes the inspection object; and the light-reflective plate is moved to a position that causes an image of the inspection object captured by the image-capturing section to be identical with an image visually observed by the inspector based on light reflected by the light-reflective plate during the image-capturing for the inspection object.

6. A visual inspection apparatus according to claim 1, further comprising:
a light-reflective-and-translucent plate disposed at a position which causes an image of the inspection object captured by the image-capturing section to be identical to an image visually observed by the inspector through the light-reflective-and-translucent plate based on light reflected by the light-reflective plate.

7. A visual inspection apparatus according to claim 1, further comprising:
an illuminating section for illuminating the inspection object;
a tilt-position-storage section for storing tilting-position-associated information associated with the inspection-object-holder section;
a tilting-position-storing-and-operating section for storing the tilting-position-associated information in the tilt-position-storage section based on operation provided by the inspector who conducts visual observation for defects of the inspection object;
a section for detecting the information associated with the line of sight for a recognizing operation provided to the tilting-position-storing-and-operating section and for detecting the information associated with the line of sight of the inspector directed toward the inspection object; and
an image-capturing-movement-control section for controlling at least one of the tilting-holder section and the image-capturing-section-moving mechanism based on the tilting-position-associated information stored in the tilt-position-storage section and the information associated with the line of sight detected by the section for detecting the information associated with the line of sight; the image-capturing-movement-control being configured to cause the position of the optical axis of the image-capturing section to be identical with the position of the line of sight of the inspector and the position of the inspection object; and the image-capturing-movement-control section conducts an image-capturing movement for the inspection object.

8. A visual inspection apparatus according to claim 7, wherein
the section for detecting the information associated with the line of sight comprises:
an inspector's-image-capturing section for capturing an image including the face of the inspector; and
an inspector's-image-processing section for calculating information associated with the line of sight of the inspector by detecting the view point position of the inspector based on the image including the face captured by the inspector's-image-capturing section.

9. A visual inspection apparatus according to claim 7, wherein
the section for detecting the information associated with the line of sight comprises:
a target-image-capturing section for capturing an image of a target provided for making a movement linking with the line of sight of the inspector; and
a target-image-processing section for calculating information associated with the line of sight of the inspector based on the image of the target captured by the target-image-capturing section.

10. A visual inspection apparatus according to claim 7, wherein
the section for detecting the information associated with the line of sight comprises:
a movable index which provides the position of the line of sight of the inspector passing between the eye view position and the inspection object during the visual observation conducted by the inspector who observes the inspection object; and
an index-position-calculating section for obtaining position-associated information of the movable index and converting the position-associated information into information associated with the line of sight of the inspector.

11. A visual inspection apparatus according to claim 7, wherein
the section for detecting the information associated with the line of sight comprises:
a position-detection sensor fixed to the inspector; and
a positional-information-calculating section for obtaining position-associated information of the position-detection sensor and converting the position-associated information into information associated with the line of sight of the inspector.
